(19) United States
(12) Patent Application Publication
(10) Pub. No.: US 2026/0252557 A1
(43) Pub. Date: Aug. 27, 2026

(54) SYSTEM

(71) Applicant: SoftBank Group Corp., Tokyo (JP)

(72) Inventor: Keyaki ISHIWATARI, Tokyo (JP)

(73) Assignee: SoftBank Group Corp., Tokyo (JP)

(21) Appl. No.: 19/542,671

(22) Filed: Feb. 18, 2026

(30) Foreign Application Priority Data
Feb. 21, 2025 (JP) 2025-026982

(51) Int. Cl. G06F 16/2452; G06F 16/21; G06F 16/242; G06F 40/284

(52) U.S. Cl. CPC G06F 16/24522; G06F 16/211; G06F 16/2433; G06F 40/284

(57) ABSTRACT

The system according to the embodiment comprises a reception unit, a collection unit, a generation unit, and a provision unit. The reception unit is configured to receive user input. The collection unit is configured to collect input content received by the reception unit. The generation unit is configured to generate an SQL query based on the input content collected by the collection unit. The provision unit is configured to provide the SQL query generated by the generation unit.

### CROSS-REFERENCE TO RELATED APPLICATION

The present application claims priority to and incorporates by reference the entire contents of Japanese Patent Application No. 2025-026982 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that users without specialized knowledge find it difficult to efficiently and accurately generate SQL queries.

### SUMMARY OF THE INVENTION

The system according to the embodiment comprises a reception unit, a collection unit, a generation unit, and a provision unit. The reception unit is configured to receive user input. The collection unit is configured to collect input content received by the reception unit. The generation unit is configured to generate an SQL query based on the input content collected by the collection unit. The provision unit is configured to provide the SQL query generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

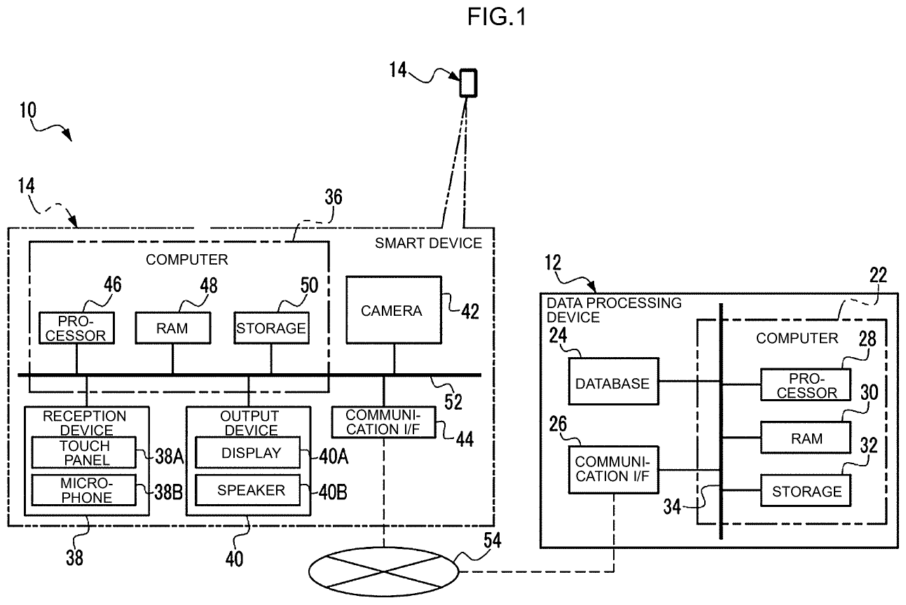

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

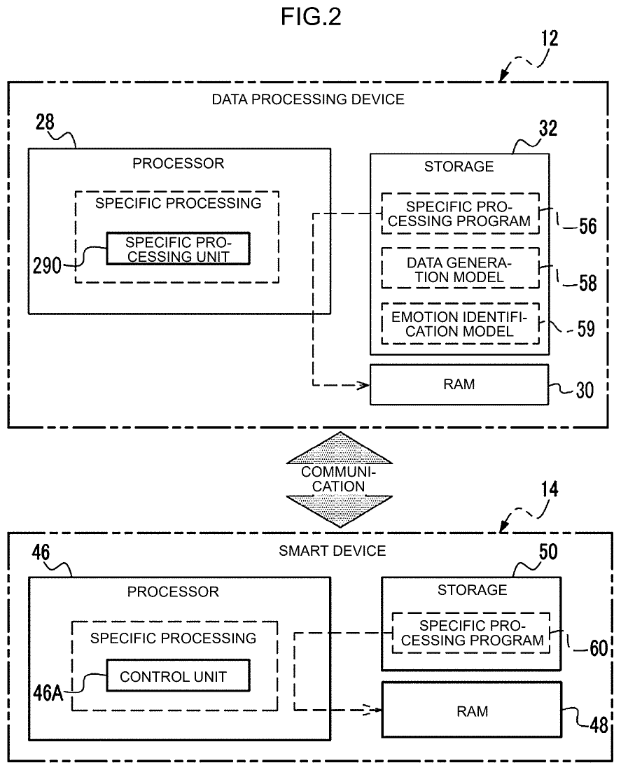

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is an AI-based system that supports automatic generation of database queries. In this system, when a user inputs data extraction conditions in a chat format, the optimal SQL query is generated. It is easy to use without requiring specialized knowledge, and enables efficient and accurate data extraction. By linking with mart definitions, the latest definitions can always be reflected, newly added items can be immediately supported, and customization for each company is also possible. For example, when a user inputs a condition such as “I want to extract sales data for 2023,” this input is sent to the AI. Next, the AI analyzes the input extraction conditions and generates the optimal SQL query. The AI understands the user's input content and, based on the database structure and mart definitions, creates an accurate SQL query. For example, a query such as “SELECT * FROM sales WHERE year=2023” is generated. The generated SQL query is provided to the user, who can execute this query on the database to extract the required data. As a result, even without specialized SQL knowledge, data can be easily extracted. Furthermore, the system can always reflect the latest definitions by linking with mart definitions. Even when new items are added, the system can immediately respond. For example, when a new sales item is added, the AI recognizes the item and generates an appropriate query. In addition, the system can be customized for each company. The optimal query can be generated according to the database structure and business content of each company. For example, queries specialized for a particular industry can be generated. Thus, the system is an AI-based system that is easy to use without specialized knowledge and enables efficient and accurate data extraction. Users can easily input data extraction conditions in a chat format, and the AI generates the optimal SQL query, allowing users to quickly obtain the necessary information from the database. As a result, the system can efficiently collect user input and generate and provide the optimal SQL query. Specifically, the system is equipped with an AI inference engine centered on large language models and Transformer-based neural networks. The system first converts natural language text input by the user in the chat UI (e.g., “I want to extract sales data for 2023,” “I want to know the number of new customers this month,” etc.) into a sequence of subword tokens (one-dimensional array, maximum length about 512 to 2048) using a tokenizer. For voice input, the voice recognition module converts the input into spectrogram images or MFCC features (two-dimensional tensor, e.g., 128×1000), and for image input, a CNN extracts feature maps (e.g., 64×64×256). These input data are preprocessed by normalization, padding, and encoding, and input to the encoder layer of the AI model. The AI model uses a pre-trained large language model (e.g., Transformer with billions of parameters) to extract structural information necessary for SQL query generation (table names, column names, conditions, operators, etc.) from the input context. The output of the AI model is provided as an SQL abstract syntax tree (AST) or token sequence (e.g., “SELECT,” “*,” “FROM,” “sales,” “WHERE,” “year,” “=,” “2023”). Examples of output include “SELECT * FROM sales WHERE year=2023” and “SELECT customer_id, amount FROM orders WHERE order_date BETWEEN ‘2023-01-01’ AND ‘2023-12-31’.” The AI model refers to database schema information and mart definitions (structured data in JSON or YAML format, e.g., table sales with columns year, amount, region, etc.) and generates queries reflecting the latest definitions. When new items are added, schema difference detection algorithms (e.g., structural comparison, hash value comparison) automatically recognize new items and reflect them in the query generation template. Customization for each company is achieved by switching rule-based preprocessing based on company ID and industry attributes, or by switching to additional fine-tuned models. The output of the AI model is presented to the user as an SQL query after threshold judgment (e.g., confidence score of 0.8 or higher) and user confirmation flow. The user can either input this query directly into the database or the system can automatically execute it and return the extraction result. As a technical effect, unlike conventional manual SQL writing or simple rule-based template generation, this system maps natural language and database structure in a high-dimensional semantic space, enabling flexible and highly accurate response to unknown inputs and newly added items. As a result, the accuracy of SQL generation automation is improved, and the efficiency, speed, and reduction of human error in data extraction operations are achieved. Application fields include business analysis for companies, sales report automation, medical data extraction, IoT log analysis, on-demand extraction of financial transaction data, and all industries where field personnel without specialized knowledge can autonomously utilize data.

The system according to the embodiment comprises a reception unit, a collection unit, a generation unit, and a provision unit. The reception unit receives user input. User input may include, for example, text input, voice input, image input, and the like, but is not limited thereto. The reception unit receives user input, for example, in a chat format. The collection unit collects input content received by the reception unit. For example, the collection unit stores the user's input content in a database. The collection unit can also organize data based on the format of the input content and the timing of collection. The generation unit generates an SQL query based on the input content collected by the collection unit. For example, the generation unit uses AI to analyze the user's input content and generate the optimal SQL query. The generation unit creates an accurate SQL query based on the database structure and mart definitions. For example, the generation unit understands the user's input content and generates a query such as “SELECT * FROM sales WHERE year=2023.” The provision unit provides the SQL query generated by the generation unit. For example, the provision unit displays the generated SQL query to the user. The provision unit can also execute the generated SQL query on the database and provide the result to the user. For example, the provision unit executes the generated SQL query on the database and displays the extracted data to the user. Thus, the system according to the embodiment can efficiently collect user input, generate the optimal SQL query, and provide it. Specifically, the system is equipped with a chat UI, voice recognition module, and image input interface as the reception unit, and receives natural language text input by the user (e.g., “I want to extract sales data for 2023”), voice data (e.g., wav format, 16 kHz, 1ch), image data (e.g., JPEG, PNG format, resolution 256×256 to 1024×1024), and so on. For voice input, the system uses a voice recognition engine (e.g., RNN-T or Transformer-based voice recognition model) to convert the voice waveform into spectrograms or MFCC features (two-dimensional tensor, such as 128×1000), and for image input, a CNN extracts feature maps (such as 64×64×256). The reception unit converts these input data into subword token sequences or vector representations using a tokenizer or encoder and passes them to the collection unit. The collection unit stores the received input data in a database (e.g., NoSQL or RDBMS) in chronological order, and organizes it by adding metadata such as input format (text, voice, image), timestamp, user ID, etc. The collection unit also performs normalization, deduplication, and preprocessing (e.g., stop word removal, noise removal) of the input content. The generation unit inputs the input content received from the collection unit into a large language model (e.g., Transformer with billions of parameters) or a multimodal AI model, and extracts structural information necessary for SQL query generation (table names, column names, conditions, operators, etc.) from the input context and features. Examples of AI model input include text such as “I want to extract sales data for 2023” (token sequence, maximum length 512), text converted from voice, and candidate table names extracted from images. The output of the AI model is provided as an SQL abstract syntax tree (AST) or token sequence (e.g., “SELECT,” “*,” “FROM,” “sales,” “WHERE,” “year,” “=,” “2023”). Examples of output include “SELECT * FROM sales WHERE year=2023” and “SELECT customer_id, amount FROM orders WHERE order_date BETWEEN ‘2023-01-01’ AND ‘2023-12-31’.” The generation unit refers to database schema information and mart definitions (structured data in JSON or YAML format, e.g., table sales with columns year, amount, region, etc.) and generates queries reflecting the latest definitions. When new items are added, schema difference detection algorithms (e.g., structural comparison, hash value comparison) automatically recognize new items and reflect them in the query generation template. For customization for each company, the generation unit switches rule-based preprocessing based on company ID and industry attributes, or switches to additional fine-tuned models to achieve optimal query generation. The output of the generation unit is passed to the provision unit as an SQL query after threshold judgment (e.g., confidence score of 0.8 or higher) and user confirmation flow. The provision unit not only displays the generated SQL query to the user, but also automatically inputs it into the database and returns the extraction result (e.g., sales data table, aggregate graph, etc.) to the user. The provision unit can also display the extraction result in visual formats such as tables, graphs, and charts. As a technical effect, unlike conventional manual SQL writing or simple rule-based template generation, this system maps natural language and database structure in a high-dimensional semantic space, enabling flexible and highly accurate response to unknown inputs and newly added items. As a result, the accuracy of SQL generation automation is improved, and the efficiency, speed, and reduction of human error in data extraction operations are achieved. Application fields include business analysis for companies, sales report automation, medical data extraction, IoT log analysis, on-demand extraction of financial transaction data, and all industries where field personnel without specialized knowledge can autonomously utilize data.

The generation unit comprises an update unit configured to update mart definitions. The generation unit comprises an update unit configured to reflect updates to mart definitions. The update unit updates mart definitions, for example, based on the structure of the data mart and the frequency of updates. For example, the update unit recognizes new items in the data mart and generates SQL queries based on those items. As a result, the generation unit can always generate SQL queries based on the latest definitions. For example, the update unit periodically checks the structure of the data mart and, when new items are added, recognizes those items and generates SQL queries. Thus, the generation unit can always generate SQL queries based on the latest definitions. Specifically, the generation unit incorporates an automatic synchronization module for data mart definitions as the update unit. The update unit periodically or upon event trigger obtains database schema information and mart definition files (e.g., structured data in JSON, YAML format including table names, column names, type information, index information, etc.), and uses difference detection algorithms (e.g., structural comparison, hash value comparison, AST tree structure comparison, etc.) to quickly extract differences from existing definitions. The update unit records difference information (e.g., new column name “amount_usd,” type “float,” addition date, etc.) as metadata and automatically reflects it in query generation templates and the input feature set of the AI model. The AI model inputs the latest schema information provided by the update unit as additional features to the encoder layer, enabling high-dimensional mapping of natural language input and database structure. For example, when a user inputs “I want to extract data including sales items added this year,” the update unit recognizes the newly added item “amount_usd,” and the AI model automatically adds the “amount_usd” column to a query such as “SELECT * FROM sales WHERE year=2023.” Examples of AI model input include natural language text (token sequence, maximum length 1024), latest schema information (JSON structure), and difference information (vectorized column addition history, etc.). The output of the AI model is provided as an SQL abstract syntax tree (AST), token sequence, or templated SQL statement (e.g., “SELECT amount_usd, amount_jpy FROM sales WHERE year=2023”). The output SQL query is passed to the provision unit after threshold judgment (confidence score of 0.85 or higher) and user confirmation flow. The update unit has parameters such as schema change detection frequency (e.g., once per day, immediate upon event occurrence) and granularity of difference reflection (e.g., column unit, table unit), which can be flexibly set according to operational requirements. As a technical effect, the introduction of the update unit eliminates the need for manual schema update reflection and template modification work, and greatly improves the automatic adaptability and responsiveness of SQL query generation to changes in database structure. As a result, even when expanding the data mart or adding new items, high-precision query generation can be continuously performed without system downtime or manual intervention, greatly improving the continuity, reliability, and operational efficiency of data extraction operations. Application fields include business analysis platforms for large enterprises with frequent schema changes, data warehouses in medical, financial, and IoT fields, multi-tenant SaaS analysis services, and all industries and business types requiring dynamic data structure management.

The generation unit comprises a customization unit configured to perform customization according to each company. The generation unit comprises a customization unit configured to perform customization according to each company. The customization unit generates optimal SQL queries, for example, based on the database structure and business content of each company. For example, the customization unit can generate queries specialized for a particular industry. As a result, the generation unit can generate optimal SQL queries tailored to the database structure and business content of each company. For example, the customization unit analyzes the database structure of each company and generates optimal SQL queries based on that structure. The customization unit also understands the business content of each company and generates optimal SQL queries based on that business content. Thus, the generation unit can generate optimal SQL queries tailored to the database structure and business content of each company. Specifically, the generation unit is equipped with a company attribute determination module and a business-specialized AI model switching mechanism as the customization unit. The customization unit receives company ID, industry code, business process definitions (e.g., sales, inventory, accounting, medical diagnosis, etc.), and database schema information (e.g., table names, column names, relation information, etc.) as input features. The customization unit first extracts the characteristics of the target company's industry, business content, and database structure using a company attribute determination algorithm (e.g., rule-based determination, clustering, metadata analysis, etc.). Next, based on the extracted features, the customization unit automatically selects a fine-tuned version of the AI model (e.g., for sales, medical, manufacturing, etc.) or rule set, and switches the query generation pipeline. For example, for sales, SQL templates prioritizing “sales,” “customer,” and “product” tables are applied, while for medical, query generation logic focusing on “patient,” “diagnosis,” and “examination” tables is applied. Examples of AI model input include user input text (e.g., “I want to extract sales data for 2023”), company ID (e.g., 12345), industry attribute (e.g., retail), and schema information (JSON structure). The output of the AI model is provided as an SQL abstract syntax tree or token sequence optimized for each company (e.g., “SELECT amount FROM sales WHERE year=2023” or “SELECT diagnosis_code FROM patient_records WHERE visit_date=‘2023-05-01’”). The customization unit automatically applies additional rules for each company (e.g., masking specific columns, changing aggregation units, etc.) and query generation parameters according to business processes (e.g., aggregation granularity, period specification method, etc.). Furthermore, the customization unit can perform continuous learning and personalization of the AI model using additional training data for each company (e.g., past query history, business term dictionaries, etc.). As a technical effect, the introduction of the customization unit enables highly accurate and flexible SQL query generation for company-specific data structures, business requirements, and terminology systems that were difficult to handle with conventional generic query generation. As a result, the automation accuracy of data extraction operations for each industry and business is improved, reducing the burden on field personnel, improving operational efficiency, and reducing human error. Application fields include industry-specialized SaaS analysis services, multi-tenant data warehouses, business analysis platforms for medical, financial, and manufacturing industries, and all business types with different data structures and business requirements for each company.

The provision unit displays an execution result of the generated SQL query. The provision unit displays an execution result of the generated SQL query. A display unit, for example, displays the execution result of the generated SQL query to the user. The display unit can also display the execution result of the generated SQL query as a graph or chart. This makes it easier for the user to check the results. For example, the display unit can display the execution result of the generated SQL query in a tabular format. The display unit can also display the execution result of the generated SQL query in a visually easy-to-understand format. Thus, the user can easily check the execution result of the generated SQL query. Some or all of the above-described processing in the display unit may be performed using AI or may be performed without using AI. For example, the display unit can input the execution result of the generated SQL query to AI, and the AI can analyze the result and display it visually. Specifically, the provision unit is equipped with an interactive visualization engine and an AI-based result analysis module as the display unit. The display unit receives as input the data table obtained as the execution result of the SQL query (e.g., two-dimensional array, number of rows N×number of columns M, each cell being a number, string, date type, etc.). The display unit first automatically analyzes data types, distributions, and category information, and selects the optimal visualization format (e.g., bar chart, line chart, pie chart, heat map, pivot table, etc.) using an AI model (e.g., decision tree, neural network, rule-based algorithm, etc.). Examples of AI model input include data tables (e.g., sales data matrix, column names “year,” “amount,” “region,” etc.), metadata (e.g., data type, number of records, number of categories, etc.), and user's past display history (e.g., preferred graph types, etc.). The output of the AI model includes visualization format labels (e.g., “bar_chart,” “table,” “pie_chart,” etc.), visualization parameters (e.g., column specification for X and Y axes, color-coded categories, etc.), and confidence scores (e.g., 0.92). For example, for sales data, “bar_chart (year, amount)” may be output, and for customer distribution data, “pie_chart (region, count)” may be output. Based on the output of the AI model, the display unit uses visualization libraries such as D3.js or Plotly to draw interactive graphs and tables in real time and present them to the user. Furthermore, the display unit can dynamically redraw the visualization content according to user operations (e.g., column selection, filtering, drill-down, etc.). The AI model also automatically performs outlier detection and summary comment generation (e.g., “Sales in 2023 increased by 20% compared to the previous year”) to provide insights to the user. As a technical effect, the introduction of the display unit enables automatic optimization of visualization, analysis, and summarization according to data content, user attributes, and past history, unlike conventional static table display or manual graph creation, thereby speeding up and improving the accuracy of data understanding and decision-making. Application fields include management analysis dashboards, automatic generation of sales reports, medical data visualization, IoT log analysis, financial transaction monitoring, and all industries and business types where visual understanding of data is important.

The reception unit estimates a user's emotion and changes a design of an input interface in real time based on the estimated user's emotion. The reception unit estimates a user's emotion and changes a design of an input interface in real time based on the estimated user's emotion. For example, if the user is feeling stressed, the reception unit provides a simple and intuitive interface and minimizes the input steps. If the user is relaxed, the reception unit provides detailed input options and can propose customizable input methods. Furthermore, if the user is in a hurry, the reception unit prioritizes voice input to enable quick entry of data extraction conditions. By changing the design of the input interface according to the user's emotion, the user's input experience can be improved. Emotion estimation is realized, for example, by using an emotion engine or generative AI with emotion estimation functions. Generative AI may be a text generation AI (e.g., LLM) or a multimodal generative AI, but is not limited thereto. Some or all of the above-described processing in the reception unit may be performed using AI or may be performed without using AI. For example, the reception unit can input the user's emotion data to generative AI and have the generative AI perform emotion estimation. Specifically, the reception unit obtains various emotion-related data from sensor devices or software modules connected to the user's input interface, such as user input text (e.g., “I'm in a hurry,” “I want to input easily”), voice data (wav format, 16 kHz), facial expression images (JPEG, 256×256), and biometric sensor values (heart rate, skin conductance, etc., one-dimensional vector). The reception unit normalizes and extracts features from these data using a preprocessing module and inputs them to an AI-based emotion estimation engine (e.g., multimodal Transformer, CNN+RNN hybrid model, etc.). Examples of AI model input include natural language text (token sequence, maximum length 256), voice spectrogram (128×1000), facial image feature map (64×64×128), and biometric signal vector (length 100). The AI model integrates these features and outputs emotion categories (e.g., stress, relaxation, tension, hurry, etc.) and emotion intensity scores (0.0 to 1.0). Examples of output include “stress: 0.85,” “relaxation: 0.15,” or “hurry: 0.92.” The reception unit uses the output results of the AI model for threshold judgment (e.g., apply simple UI if stress score is 0.7 or higher) or rule-based branching, and reflects them in the interface generation module in real time. For example, if stress is high, the number of input items is minimized and the voice input button is emphasized; if relaxed, the detailed settings panel is expanded. Furthermore, if the user is in a hurry, the voice recognition module is automatically activated and input completion candidates are immediately presented. Unlike conventional static UI design or simple user attribute branching, this reception unit is technically characterized by AI estimating emotional states in a high-dimensional feature space and dynamically generating interfaces based on non-conventional rule sets. As a technical effect, the reception unit automatically generates the optimal UI according to the user's real-time emotional state, thereby greatly reducing input errors and dropout rates, and significantly improving input efficiency, user satisfaction, and overall business productivity. Application fields include business systems for companies, medical interview input in medical settings, identity verification in financial services, operator support in call centers, and learning support UIs in education, and all industries and business types requiring interface optimization according to the user's psychological state.

The reception unit analyzes a user's past input history and proposes an appropriate input method. The reception unit analyzes a user's past input history and proposes an appropriate input method. For example, extraction conditions frequently input by the user in the past are automatically displayed as candidates. The reception unit can also preferentially propose input methods (voice, text, etc.) that the user has used in the past. Furthermore, the reception unit can predict and propose extraction conditions used at specific times based on the user's past input history. By analyzing the user's past input history, the optimal input method can be proposed, improving input efficiency. Some or all of the above-described processing in the reception unit may be performed using AI or may be performed without using AI. For example, the reception unit can input the user's past input history data to generative AI and have the generative AI propose the optimal input method. Specifically, the reception unit refers to an input history database recorded chronologically for each user (e.g., NoSQL type, RDBMS type, with metadata such as input date and time, input content, input method, device type, etc. for each record). The reception unit extracts history data as a chronological array (e.g., past 30 days, up to 50 entries per day, two-dimensional array), and performs normalization, deduplication, and feature extraction (e.g., input frequency, input method distribution, time-of-day trends, etc.) using a preprocessing module. An AI-based history analysis engine (e.g., time-series RNN, Transformer Encoder, clustering algorithm, etc.) inputs these features and generates an input tendency model for each user. Examples of AI model input include input content token sequence (maximum length 256), input method category (one-hot vector), input time (24-hour representation), and device type (smartphone, PC, etc.). The AI model predicts the input method most likely to be used next time (e.g., voice, text), candidate input content (e.g., “sales for this month,” “inventory list,” etc.), and recommended extraction conditions by time of day (e.g., sales in the morning, inventory in the afternoon, etc.), and outputs them as probability distributions or score lists. Examples of output include “voice input: 0.7, text input: 0.3,” “candidates: sales for this month (0.8), inventory list (0.6),” etc. The reception unit sorts the output results of the AI model by threshold judgment or ranking and automatically displays them in the chat UI or input assistance panel. Furthermore, by preferentially suggesting conditions frequently used by the user at specific times, the input effort can be greatly reduced. Unlike conventional simple history list display or static templates, this reception unit is technically characterized by combining high-dimensional feature extraction and time-series prediction by AI to propose input methods and content optimized for each user in real time. As a technical effect, the reception unit learns the user's input tendencies and automatically presents the optimal input method and content, greatly improving input efficiency, business speed, and user satisfaction. Application fields include sales support systems, medical interview systems, financial transaction terminals, customer support chat, IoT device management, and all industries and business types where input tendencies differ for each user.

The reception unit adds a function to immediately perform input completion according to the user's input content. The reception unit adds a function to immediately perform input completion according to the user's input content. For example, when the user inputs extraction conditions, AI presents candidates in real time and completes the input. If the user inputs partial conditions, AI can propose optimal completion candidates. Furthermore, if the user inputs ambiguous conditions, AI can present specific candidates and complete the input. By performing input completion in real time according to the user's input content, input efficiency can be improved. Some or all of the above-described processing in the reception unit may be performed using AI or may be performed without using AI. For example, the reception unit can input the user's input content to generative AI and have the generative AI perform input completion. Specifically, the reception unit converts text input by the user in the chat UI or voice input interface (e.g., “sales for 2023” or “for this month,” token sequence, maximum length 128) and voice recognition results into subword token sequences using a tokenizer. The reception unit inputs these partial or ambiguous inputs to an AI-based input completion engine (e.g., large language model, BERT or Transformer Decoder, etc.). Examples of AI model input include partial SQL condition statements (e.g., “SELECT * FROM sales WHERE”), natural language fragments (e.g., “sales for 2023”), past input history (time-series vector), and user attribute information (one-hot vector). The AI model outputs next token predictions for the SQL syntax tree, mapping candidates from natural language to SQL, and concretization of ambiguous words (e.g., “this month”→“2023-06,” etc.). Examples of output include SQL condition candidates such as “year=2023,” “amount>1000,” “order_date BETWEEN ‘2023-01-01’ AND ‘2023-12-31’,” and natural language completion candidates such as “sales data,” “number of new customers,” etc. The reception unit arranges the AI model's output candidates in order of confidence score and presents them to the user in real time, allowing the user to select or automatically complete the input. Furthermore, when the user inputs ambiguous expressions, AI refers to past history and database schema information to estimate and complete the most appropriate specific value. Unlike conventional static suggest functions or simple dictionary-based completion, this reception unit is technically characterized by realizing input completion in a high-dimensional semantic space by AI, enabling flexible response to unknown or ambiguous input. As a technical effect, the reception unit automates and improves the accuracy of input completion, thereby improving input efficiency, reducing errors, and enhancing user experience. Application fields include data extraction UIs for business systems, medical questionnaires, financial transaction terminals, IoT device setting screens, and all industries and business types where input completion efficiency is required.

The reception unit estimates a user's emotion and sets a priority of input based on the estimated user's emotion. The reception unit estimates a user's emotion and sets a priority of input based on the estimated user's emotion. For example, if the user is feeling stressed, important input items are preferentially displayed to enable quick input. If the user is relaxed, detailed input options are provided and customizable input methods can be proposed. Furthermore, if the user is in a hurry, the most important input items are preferentially displayed to enable quick input. By determining the priority of input according to the user's emotion, important input items can be preferentially processed. Emotion estimation is realized, for example, by using an emotion engine or generative AI with emotion estimation functions. Generative AI may be a text generation AI (e.g., LLM) or a multimodal generative AI, but is not limited thereto. Some or all of the above-described processing in the reception unit may be performed using AI or may be performed without using AI. For example, the reception unit can input the user's emotion data to generative AI and have the generative AI perform emotion estimation. Specifically, the reception unit obtains emotion-related data such as user input text, voice, facial expression images, and biometric sensor values, and extracts features using a preprocessing module. An AI-based emotion estimation engine (e.g., multimodal Transformer, CNN+RNN hybrid model) inputs these features and outputs emotion categories (e.g., stress, relaxation, hurry, etc.) and emotion intensity scores. Examples of AI model input include natural language text (token sequence), voice spectrogram, facial image feature map, and biometric signal vector. The AI model outputs emotion category labels (e.g., “stress”), emotion intensity scores (e.g., 0.85), etc. The reception unit uses the output results of the AI model for threshold judgment or rule-based branching and reflects them in the input item priority determination module. For example, if stress is high, only required items are displayed and input steps are shortened; if relaxed, detailed options are expanded and customization items are added; if in a hurry, voice input is prioritized and only the most important items are displayed. Unlike conventional static input item display or simple user attribute branching, this reception unit is technically characterized by combining high-dimensional emotion estimation by AI and dynamic priority control to realize an input flow optimized for the user's state. As a technical effect, the reception unit greatly improves input efficiency, business speed, and user satisfaction by prioritizing important items and optimizing input steps. Application fields include medical interview systems, financial transaction terminals, sales support tools, customer support chat, and all industries and business types requiring input priority control according to user state.

The reception unit provides a region-specific input format based on the user's geographic location information. The reception unit provides a region-specific input format based on the user's geographic location information. For example, if the user is in a specific region, the system automatically provides a data format specific to that region. The reception unit can also propose region-specific input options based on the user's geographic location information. Furthermore, when the user moves to a different region, the system can automatically switch to an input format suitable for that region. By considering the user's geographic location information, region-specific input formats can be provided, improving input efficiency. Some or all of the above-described processing in the reception unit may be performed using AI or may be performed without using AI. For example, the reception unit can input the user's geographic location information to generative AI and have the generative AI provide region-specific input formats. Specifically, the reception unit obtains geographic location data (latitude/longitude, country/region code, city name, etc.) from the user's device GPS, IP address, Wi-Fi location information, etc. The reception unit normalizes these location data using a preprocessing module and inputs them to an AI-based region identification engine (e.g., geographic information clustering model, rule-based+neural network). Examples of AI model input include latitude/longitude vector (2D), country code (one-hot vector), city name (token sequence), and user attribute information. The AI model outputs region-specific input formats (e.g., date format “YYYY/MM/DD” or “MM-DD-YYYY,” currency unit “yen,” “dollar,” address input order, language settings, etc.) and input options (e.g., region-limited choices, local business terms, etc.). Examples of output include “date format: YYYY/MM/DD,” “currency: yen,” “address order: prefecture→city/ward/town→street number,” etc. The reception unit reflects the output results of the AI model in the interface generation module, enabling the user to input data in the optimal format for the region. Furthermore, when the user moves to a different region, the system automatically switches the input format triggered by the change in location information. Unlike conventional static region settings or manual switching, this reception unit is technically characterized by combining high-dimensional location information analysis by AI and dynamic UI generation to automate region-specific input optimization. As a technical effect, the reception unit automatically applies input formats according to business requirements, legal regulations, and user habits for each region, greatly reducing input errors, business errors, and user burden, and enabling efficient global deployment and multi-site operation. Application fields include business systems for international companies, global e-commerce sites, multi-region support UIs for medical, financial, and logistics, and all industries and business types requiring region-specific input optimization.

The reception unit analyzes a user's social media activity and proposes appropriate input content. The reception unit analyzes a user's social media activity and proposes appropriate input content. For example, the system analyzes the user's social media posts and proposes related data extraction conditions. The system can also extract topics of interest from the user's social media activity and propose related input content. Furthermore, by analyzing the user's activity time on social media, the system can propose the optimal input timing. By analyzing the user's social media activity, the system can propose related input content and improve input efficiency. Some or all of the above-described processing in the reception unit may be performed using AI or may be performed without using AI. For example, the reception unit can input the user's social media activity data to generative AI and have the generative AI propose appropriate input content. Specifically, the reception unit obtains post data (e.g., text, images, post date/time, number of likes, hashtags, etc.) and activity logs (e.g., posting frequency, active time, follow relationships, etc.) from social media APIs within the scope permitted by the user. The reception unit normalizes and extracts features from these data using a preprocessing module and inputs them to an AI-based social analysis engine (e.g., BERT-based natural language processing model, topic modeling, time-series clustering, etc.). Examples of AI model input include post text (token sequence, maximum length 512), post image features (CNN-extracted vector), post time (24-hour representation), and hashtag list (one-hot vector). The AI model outputs topics of interest to the user (e.g., “sales,” “new products,” “inventory,” etc.), related data extraction conditions (e.g., “sales for this month,” “number of new customers,” etc.), and optimal input timing (e.g., morning, weekend, etc.). Examples of output include “recommended input content: sales for this month,” “recommended timing: 10 a.m.,” etc. The reception unit automatically displays the output results of the AI model in the chat UI or input assistance panel, allowing the user to select input content with one click. Furthermore, the system can optimize timing by displaying input assistance pop-ups according to the user's activity time. Unlike conventional static templates or simple history suggestions, this reception unit is technically characterized by combining high-dimensional social data analysis by AI and dynamic input proposals to optimize input according to the user's interests and behavior. As a technical effect, the reception unit greatly improves input efficiency, business speed, and user satisfaction by automatically proposing input content and timing based on the user's interests and behavior patterns. Application fields include sales support systems, marketing analysis tools, customer support chat, personalized UIs for medical and financial fields, and all industries and business types requiring input optimization utilizing user social activity.

The collection unit estimates a user's emotion and adjusts a range of data to be collected based on the estimated user's emotion. The collection unit estimates a user's emotion and adjusts a range of data to be collected based on the estimated user's emotion. For example, if the user is feeling stressed, the collection unit collects only the minimum necessary data. If the user is relaxed, the collection unit can collect detailed data. Furthermore, if the user is in a hurry, the collection unit can set a data range that can be collected quickly. By adjusting the range of data to be collected according to the user's emotion, necessary data can be efficiently collected. Emotion estimation is realized, for example, by using an emotion engine or generative AI with emotion estimation functions. Generative AI may be a text generation AI (e.g., LLM) or a multimodal generative AI, but is not limited thereto. Some or all of the above-described processing in the collection unit may be performed using AI or may be performed without using AI. For example, the collection unit can input the user's emotion data to generative AI and have the generative AI adjust the range of data to be collected. Specifically, the collection unit normalizes and extracts features from emotion-related data obtained from the user's input interface or connected sensor devices (e.g., natural language text, voice waveform, facial expression images, biometric sensor values, etc.) using a preprocessing module, and inputs them to an AI-based emotion estimation engine such as a multimodal Transformer or CNN+RNN hybrid model. The collection unit uses as AI model input natural language text (token sequence, maximum length 256), voice spectrogram (128×1000), facial image feature map (64×64×128), and biometric signal vector (length 100). The AI model integrates these features and outputs emotion categories (e.g., stress, relaxation, hurry, etc.) and emotion intensity scores (0.0 to 1.0). Examples of output include “stress: 0.85,” “relaxation: 0.15,” “hurry: 0.92,” etc. The collection unit uses the output results of the AI model for threshold judgment (e.g., collect minimum data if stress score is 0.7 or higher) or rule-based branching, and reflects them in the data range determination module in real time. For example, if stress is high, only required items such as “user ID, date/time, main conditions” are collected; if relaxed, additional items such as “detailed business content, device information, operation logs” are also collected; if in a hurry, the collection target is limited to the most recent input content to speed up the collection process. The AI model outputs collection range parameters (e.g., list of collection items, collection granularity, collection timeout value, etc.) as structured data. For example, “collection items: user ID, extraction conditions, input time,” “collection granularity: low,” “timeout: 1 second,” etc. The collection unit extracts only the necessary data from the database or storage based on these parameters, suppressing unnecessary data collection, storage, and transfer. Unlike conventional uniform collection or static rule-based collection, this collection unit is technically characterized by combining high-dimensional emotion estimation by AI and dynamic collection range control to realize a data collection flow optimized for the user's state. As a technical effect, the collection unit automatically determines the optimal data collection range according to the user's real-time emotional state, greatly reducing system-wide data transfer volume, storage load, and processing delay, and significantly improving business efficiency, user experience, and system operation cost. Application fields include minimum data collection during patient stress in medical interview systems, emergency data collection optimization in financial transaction terminals, expanded data collection during detailed analysis in sales support systems, and all industries and business types requiring data collection optimization according to user state.

The collection unit refers to a user's past input content during collection to improve collection accuracy. The collection unit refers to a user's past input content during collection to improve collection accuracy. For example, based on conditions input by the user in the past, the collection unit preferentially collects related data. The collection unit can also improve the accuracy of data collection based on the user's past input content. Furthermore, by analyzing the user's past input history, the collection unit can propose the optimal data collection method. By referring to the user's past input content, collection accuracy can be improved. Some or all of the above-described processing in the collection unit may be performed using AI or may be performed without using AI. For example, the collection unit can input the user's past input content data to generative AI and have the generative AI improve collection accuracy. Specifically, the collection unit refers to an input history database recorded chronologically for each user (e.g., NoSQL type, RDBMS type, with metadata such as input date and time, input content, input method, device type, etc. for each record). The collection unit extracts history data as a chronological array (e.g., past 30 days, up to 50 entries per day, two-dimensional array), and performs normalization, deduplication, and feature extraction (e.g., input frequency, input method distribution, time-of-day trends, etc.) using a preprocessing module. An AI-based history analysis engine (e.g., time-series RNN, Transformer Encoder, clustering algorithm, etc.) inputs these features and generates an input tendency model for each user. Examples of AI model input include input content token sequence (maximum length 256), input method category (one-hot vector), input time (24-hour representation), and device type (smartphone, PC, etc.). The AI model predicts the input method most likely to be used next time (e.g., voice, text), candidate input content (e.g., “sales for this month,” “inventory list,” etc.), and recommended extraction conditions by time of day (e.g., sales in the morning, inventory in the afternoon, etc.), and outputs them as probability distributions or score lists. Examples of output include “voice input: 0.7, text input: 0.3,” “candidates: sales for this month (0.8), inventory list (0.6),” etc. The collection unit sorts the output results of the AI model by threshold judgment or ranking and automatically determines the priority of target data and collection method (e.g., batch collection, real-time collection, partial collection, etc.). Furthermore, by preferentially suggesting conditions frequently used by the user at specific times, the accuracy and relevance of target data collection are improved. Unlike conventional simple history list reference or static template collection, this collection unit is technically characterized by combining high-dimensional feature extraction and time-series prediction by AI to realize improved data collection accuracy optimized for each user. As a technical effect, the collection unit learns the user's input tendencies and automatically presents and applies the optimal data collection method and content, greatly improving collection accuracy, business speed, and user satisfaction. Application fields include sales support systems, medical interview systems, financial transaction terminals, customer support chat, IoT device management, and all industries and business types where input tendencies differ for each user.

The collection unit filters collected data during collection based on a user's current business status. The collection unit filters collected data during collection based on a user's current business status. For example, if the user is performing a specific business operation, the collection unit preferentially collects data related to that business. The collection unit can also filter out unnecessary data based on the user's business status. Furthermore, the collection unit can propose the optimal data collection method according to the user's business content. By filtering collected data based on the user's current business status, necessary data can be efficiently collected. Some or all of the above-described processing in the collection unit may be performed using AI or may be performed without using AI. For example, the collection unit can input the user's business status data to generative AI and have the generative AI perform data filtering. Specifically, the collection unit normalizes and extracts features from business status data obtained from the user's business process management system or business applications (e.g., current business type, ongoing tasks, business flow status, business attribute code, etc.) using a preprocessing module, and inputs them to an AI-based business status analysis engine (e.g., rule-based+neural network, business-specialized Transformer, etc.). The collection unit uses as AI model input business type (one-hot vector), task progress (numeric scalar), business flow status (token sequence), and business attribute (category vector). The AI model outputs priority scores for target data and filtering rules (e.g., during sales operations, only sales and customer data; during inventory management, only inventory and in/out data, etc.). Examples of output include “target: sales data, customer data,” “filter: exclude inventory data,” “priority: high,” etc. The collection unit automatically excludes unnecessary data from the collection dataset based on the output results of the AI model and extracts only the necessary data. Furthermore, the collection unit automatically adjusts the collection method (e.g., real-time, batch, event-triggered, etc.) and collection granularity (e.g., daily, monthly, detail unit, etc.) according to business content. Unlike conventional static business rules or manual filtering, this collection unit is technically characterized by combining high-dimensional business status analysis by AI and dynamic data filtering to realize a data collection flow optimized for business status. As a technical effect, the collection unit suppresses unnecessary data collection, storage, and transfer, and greatly improves business efficiency, system load, and data quality by optimizing data filtering and collection according to business status. Application fields include process management in manufacturing sites, collection of medical records in medical settings, collection of transaction data in financial operations, sales support systems, and all industries and business types requiring data collection optimization according to business content.

The collection unit estimates a user's emotion and determines a priority of collected data based on the estimated user's emotion. The collection unit estimates a user's emotion and determines a priority of collected data based on the estimated user's emotion. For example, if the user is feeling stressed, the collection unit preferentially collects important data. If the user is relaxed, the collection unit can preferentially collect detailed data. Furthermore, if the user is in a hurry, the collection unit can preferentially collect data that can be collected quickly. By determining the priority of collected data according to the user's emotion, important data can be preferentially collected. Emotion estimation is realized, for example, by using an emotion engine or generative AI with emotion estimation functions. Generative AI may be a text generation AI (e.g., LLM) or a multimodal generative AI, but is not limited thereto. Some or all of the above-described processing in the collection unit may be performed using AI or may be performed without using AI. For example, the collection unit can input the user's emotion data to generative AI and have the generative AI determine the priority of collected data. Specifically, the collection unit normalizes and extracts features from emotion-related data obtained from the user's input interface or sensor devices (e.g., natural language text, voice waveform, facial expression images, biometric sensor values, etc.) using a preprocessing module, and inputs them to an AI-based emotion estimation engine such as a multimodal Transformer or CNN+RNN hybrid model. The collection unit uses as AI model input natural language text (token sequence, maximum length 256), voice spectrogram (128×1000), facial image feature map (64×64×128), and biometric signal vector (length 100). The AI model integrates these features and outputs emotion categories (e.g., stress, relaxation, hurry, etc.) and emotion intensity scores (0.0 to 1.0). Examples of output include “stress: 0.85,” “relaxation: 0.15,” “hurry: 0.92,” etc. The collection unit uses the output results of the AI model for threshold judgment (e.g., prioritize important data if stress score is 0.7 or higher) or rule-based branching, and reflects them in the data priority determination module in real time. For example, if stress is high, only required items and main conditions are preferentially collected; if relaxed, detailed items and supplementary information are also preferentially collected; if in a hurry, data that can be obtained immediately is prioritized for collection. The AI model outputs a data priority list (e.g., list of data items with priority scores) as structured data. For example, “user ID: 1.0, extraction condition: 0.9, business content: 0.7, operation log: 0.3,” etc. The collection unit collects high-priority data first from the database or storage based on these priorities, and low-priority data is collected later or omitted. Unlike conventional uniform collection or static priority setting, this collection unit is technically characterized by combining high-dimensional emotion estimation by AI and dynamic priority control to realize a data collection flow optimized for the user's state. As a technical effect, the collection unit greatly improves collection efficiency, business speed, and user satisfaction by prioritizing important items and optimizing collection procedures. Application fields include medical interview systems, financial transaction terminals, sales support tools, customer support chat, and all industries and business types requiring data collection priority control according to user state.

The collection unit preferentially collects highly relevant data by considering a user's geographic location information during collection. The collection unit preferentially collects highly relevant data by considering a user's geographic location information during collection. For example, if the user is in a specific region, the collection unit preferentially collects data related to that region. The collection unit can also preferentially collect highly relevant data based on the user's geographic location information. Furthermore, when the user moves to a different region, the collection unit can preferentially collect data related to that region. By considering the user's geographic location information, highly relevant data can be preferentially collected. Some or all of the above-described processing in the collection unit may be performed using AI or may be performed without using AI. For example, the collection unit can input the user's geographic location information to generative AI and have the generative AI collect highly relevant data. Specifically, the collection unit obtains geographic location data (latitude/longitude, country/region code, city name, etc.) from the user's device GPS, IP address, Wi-Fi location information, etc., and normalizes and extracts features using a preprocessing module. The collection unit inputs latitude/longitude vector (2D), country code (one-hot vector), city name (token sequence), and user attribute information to an AI-based region identification engine (e.g., geographic information clustering model, rule-based+neural network). The AI model outputs region-specific relevant data categories (e.g., region-limited products, local business data, region-specific regulatory data, etc.) and collection priority scores. Examples of output include “target: Tokyo sales data, Kansai area inventory data,” “priority: high,” etc. The collection unit preferentially extracts regionally relevant data from the collection dataset based on the output results of the AI model, and data from other regions is collected later or omitted. Furthermore, when the user moves to a different region, the system automatically switches the target data for collection triggered by the change in location information. The AI model outputs a collection target list (list of data items for each region with priority scores) as structured data. For example, “region: Tokyo, items: sales, inventory, priority: 0.95,” etc. Unlike conventional static region settings or manual switching, this collection unit is technically characterized by combining high-dimensional location information analysis by AI and dynamic data collection optimization to automate region-specific data collection. As a technical effect, the collection unit automatically applies data collection according to business requirements, legal regulations, and user habits for each region, greatly reducing collection errors, business errors, and user burden, and enabling efficient global deployment and multi-site operation. Application fields include business systems for international companies, global e-commerce sites, multi-region data collection for medical, financial, and logistics, and all industries and business types requiring region-specific data collection optimization.

The collection unit analyzes a user's social media activity during collection and collects relevant data. The collection unit analyzes a user's social media activity during collection and collects relevant data. For example, the collection unit analyzes the user's social media posts and collects relevant data. The collection unit can also collect data related to topics of interest extracted from the user's social media activity. Furthermore, by analyzing the user's activity time on social media, the collection unit can propose the optimal data collection timing. By analyzing the user's social media activity, relevant data can be efficiently collected. Some or all of the above-described processing in the collection unit may be performed using AI or may be performed without using AI. For example, the collection unit can input the user's social media activity data to generative AI and have the generative AI collect relevant data. Specifically, the collection unit obtains post data (e.g., text, images, post date/time, number of likes, hashtags, etc.) and activity logs (e.g., posting frequency, active time, follow relationships, etc.) from social media APIs within the scope permitted by the user. The collection unit normalizes and extracts features from these data using a preprocessing module and inputs them to an AI-based social analysis engine (e.g., BERT-based natural language processing model, topic modeling, time-series clustering, etc.). Examples of AI model input include post text (token sequence, maximum length 512), post image features (CNN-extracted vector), post time (24-hour representation), and hashtag list (one-hot vector). The AI model outputs topics of interest to the user (e.g., “sales,” “new products,” “inventory,” etc.), related data categories (e.g., “sales for this month,” “number of new customers,” etc.), and optimal collection timing (e.g., morning, weekend, etc.). Examples of output include “target: sales for this month,” “recommended timing: 10 a.m. ,” etc. The collection unit automatically determines target data and collection timing based on the output results of the AI model, realizing data collection tailored to the user's interests and behavior. Furthermore, by scheduling collection processing according to the user's activity time, the freshness and relevance of data are improved. Unlike conventional static templates or simple history suggestions, this collection unit is technically characterized by combining high-dimensional social data analysis by AI and dynamic data collection optimization to realize data collection tailored to the user's interests and behavior. As a technical effect, the collection unit greatly improves collection efficiency, business speed, and user satisfaction by automatically optimizing data collection content and timing based on the user's interests and behavior patterns. Application fields include sales support systems, marketing analysis tools, customer support chat, personalized data collection for medical and financial fields, and all industries and business types requiring data collection optimization utilizing user social activity.

The generation unit estimates a user's emotion and adjusts an expression method of the SQL query to be generated based on the estimated user's emotion. The generation unit estimates a user's emotion and adjusts an expression method of the SQL query to be generated based on the estimated user's emotion. For example, if the user is relaxed, the generation unit generates an SQL query including detailed explanations. If the user is in a hurry, the generation unit generates concise and efficient SQL queries. Furthermore, if the user is feeling stressed, the generation unit can generate simple and intuitive SQL queries. By adjusting the expression method of the SQL query according to the user's emotion, queries that are easy for the user to understand can be generated. Emotion estimation is realized, for example, by using an emotion engine or generative AI with emotion estimation functions. Generative AI may be a text generation AI (e.g., LLM) or a multimodal generative AI, but is not limited thereto. Some or all of the above-described processing in the generation unit may be performed using AI or may be performed without using AI. For example, the generation unit can input the user's emotion data to generative AI and have the generative AI adjust the expression method of the SQL query. Specifically, the generation unit normalizes and extracts features from emotion-related data obtained from the user's input interface or sensor devices (e.g., natural language text, voice waveform, facial expression images, biometric sensor values, etc.) using a preprocessing module, and inputs them to an AI-based emotion estimation engine such as a multimodal Transformer or CNN+RNN hybrid model. The generation unit uses as AI model input natural language text (token sequence, maximum length 256), voice spectrogram (128×1000), facial image feature map (64×64×128), and biometric signal vector (length 100). The AI model integrates these features and outputs emotion categories (e.g., stress, relaxation, hurry, etc.) and emotion intensity scores (0.0 to 1.0). Examples of output include “stress: 0.85,” “relaxation: 0.15,” “hurry: 0.92,” etc. The generation unit uses the output results of the AI model for threshold judgment (e.g., apply simple expression if stress score is 0.7 or higher) or rule-based branching, and reflects them in the SQL query generation template or output format selection module in real time. For example, if stress is high, a minimal query such as “SELECT * FROM sales WHERE year=2023” is generated; if relaxed, a query with comments and detailed explanations such as “--Query to extract sales data for 2023

[symbol]

SELECT amount, region, product FROM sales WHERE year=2023” is generated; if in a hurry, queries prioritizing execution speed such as those using indexes or LIMIT clauses are generated. The AI model outputs SQL abstract syntax trees (AST), token sequences, templated SQL statements, SQL statements with explanatory comments, and other formats. Furthermore, the generation unit dynamically sets parameters for readability, execution efficiency, and explanation granularity of the query according to the user's emotional state (e.g., whether to insert comments, column selection granularity, detail level of WHERE clause, etc.). Unlike conventional static query generation or uniform template output, this generation unit is technically characterized by combining high-dimensional emotion estimation by AI and dynamic query expression control to realize SQL query generation optimized for the user's state. As a technical effect, the generation unit automatically generates the optimal query expression according to the user's real-time emotional state, greatly improving query comprehension, execution efficiency, user satisfaction, and overall business productivity. Application fields include business analysis platforms for companies, medical data extraction, financial transaction analysis, sales support systems, SQL learning support in education, and all industries and business types requiring query expression optimization according to user state.

The generation unit generates an optimal query by considering a database load during generation. The generation unit generates an optimal query by considering a database load during generation. For example, if the database load is high, the generation unit generates efficient queries. If the database load is low, the generation unit can generate queries to obtain detailed data. Furthermore, the generation unit can generate optimal queries according to the database load status. By considering the database load, efficient queries can be generated. Some or all of the above-described processing in the generation unit may be performed using AI or may be performed without using AI. For example, the generation unit can input database load status data to generative AI and have the generative AI generate optimal queries. Specifically, the generation unit normalizes and extracts features from load status data obtained from the database monitoring module (e.g., CPU usage, number of concurrent connections, query queue length, I/O throughput, etc., time-series vectors or scalar values) using a preprocessing module, and inputs them to an AI-based load analysis engine (e.g., time-series RNN, LSTM, rule-based+neural network). The generation unit uses as AI model input load indicator vectors (e.g., CPU 80%, connections 50, I/O 200 MB/s), past query execution history (two-dimensional array), and database type (one-hot vector). The AI model outputs query execution load prediction scores, recommended query types (e.g., aggregation query, partial extraction query, index utilization query, etc.), and query optimization parameters (e.g., add LIMIT clause, avoid JOIN, narrow WHERE clause, etc.). Examples of output include “recommended query type: partial extraction,” “apply LIMIT 100,” “add WHERE clause,” “avoid JOIN,” etc. The generation unit reflects the output results of the AI model in the SQL query generation template or query optimization module in real time and automatically generates optimal queries according to the load status. For example, if the load is high, a limited query such as “SELECT amount FROM sales WHERE year=2023 LIMIT 100” is generated; if the load is low, a full extraction query such as “SELECT * FROM sales WHERE year=2023” is generated. Furthermore, the AI model outputs cost estimates for query execution plans and index utilization, and the query generation unit automatically adjusts optimization parameters. Unlike conventional static query generation or manual optimization, this generation unit is technically characterized by combining high-dimensional load analysis by AI and dynamic query optimization to realize query generation optimized for system status. As a technical effect, the generation unit automatically optimizes queries according to database load status, greatly improving system-wide response speed, stability, resource efficiency, and business continuity. Application fields include analysis platforms for large enterprises, high-load data warehouses in medical and financial fields, IoT log analysis, multi-tenant SaaS services, and all industries and business types requiring query generation robust to load fluctuations.

The generation unit applies different generation algorithms according to the user's business content at the time of generation. For example, when the user is engaged in sales operations, the generation unit generates queries specialized for sales data. In addition, when the user is engaged in inventory management operations, the generation unit can generate queries specialized for inventory data. Furthermore, the generation unit can apply the optimal generation algorithm according to the user's business content. By applying the optimal generation algorithm according to the user's business content, queries suitable for the business can be generated. Some or all of the above-described processing in the generation unit may be performed using AI, or may be performed without using AI. For example, the generation unit can input the user's business content data to a generation AI and have the generation AI apply the optimal generation algorithm. Specifically, the generation unit normalizes and extracts features from business content data (e.g., business type, ongoing tasks, business flow status, business attribute codes, etc.) obtained from the user's business process management system or business applications using a preprocessing module, and inputs them to an AI-based business content analysis engine (e.g., rule-based+neural network, business-specialized Transformer, etc.). The generation unit uses, as AI model inputs, business type (one-hot vector), task progress (numeric scalar), business flow status (token sequence), and business attributes (category vector), among others. The AI model outputs, based on this information, the optimal query generation algorithm (e.g., sales business template, inventory management template, accounting business template, etc.) and parameters (e.g., aggregation granularity, period specification method, JOIN structure, etc.). Example outputs include “Apply sales business template,” “Aggregation granularity: monthly,” “JOIN: customer table,” and so on. The generation unit automatically switches the query generation pipeline and template selection module based on the AI model output, generating SQL queries optimized for the business content. For example, during sales operations, “SELECT amount FROM sales WHERE year=2023” is automatically generated, and during inventory management, “SELECT stock_level FROM inventory WHERE product_id=‘A123’” is generated, thus automatically generating business-specialized queries. Furthermore, the AI model can handle changes in business content and simultaneous progress of multiple businesses, enabling combinations of multiple templates and dynamic parameter adjustments. Unlike conventional static query generation and manual business switching, the generation unit combines high-dimensional business content analysis by AI and dynamic algorithm selection to realize query generation optimized for business status, which is a technical feature. As a technical effect, the generation unit greatly improves business efficiency, data extraction accuracy, user satisfaction, and overall business productivity by automatically optimizing queries according to business content. Application fields include process management in manufacturing sites, extraction of medical records in medical sites, transaction data analysis in financial operations, sales support systems, and all industries and business types where query generation optimization according to business content is required.

The generation unit estimates the user's emotion and determines the priority of SQL queries to be generated based on the estimated user's emotion. For example, if the user is feeling stressed, the generation unit prioritizes the generation of important queries. If the user is relaxed, the generation unit can prioritize the generation of detailed queries. Furthermore, if the user is in a hurry, the generation unit can prioritize the generation of queries that can be generated quickly. By determining the priority of SQL queries according to the user's emotion, important queries can be generated preferentially. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the generation unit may be performed using AI, or may be performed without using AI. For example, the generation unit can input the user's emotion data to a generation AI and have the generation AI determine the priority of SQL queries. Specifically, the generation unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The generation unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., stress, relaxation, urgency, etc.) and emotion intensity scores (0.0-1.0). Example outputs include “Stress: 0.85,” “Relaxation: 0.15,” “Urgency: 0.92,” and so on. The generation unit uses the AI model output for threshold judgment (e.g., prioritize important queries if stress score is 0.7 or higher) or rule-based branching, and reflects it in the query generation priority decision module in real time. For example, if stress is high, essential queries such as “sales data extraction” are generated preferentially; if relaxed, “detailed analysis queries” and “auxiliary information extraction queries” are also prioritized; if in a hurry, “execution speed-focused queries” and “partial extraction queries” are prioritized. The AI model output is structured as a query priority list (e.g., a list with priority scores for each query). For example, “Sales extraction: 1.0, Inventory analysis: 0.8, Detailed analysis: 0.5,” and so on. The generation unit automatically controls the query generation pipeline and template selection module based on these priorities, realizing query generation optimized for the user's state. Unlike conventional uniform query generation or static priority settings, the generation unit combines high-dimensional emotion estimation by AI and dynamic priority control to realize a query generation flow optimized for the user's state, which is a technical feature. As a technical effect, the generation unit greatly improves query generation efficiency, business speed, and user satisfaction by prioritizing important items and optimizing generation procedures. Application fields include medical interview systems, financial transaction terminals, sales support tools, customer support chat, and all industries and business types where query generation priority control according to user state is required.

The generation unit generates optimal queries by considering the geographic distribution of databases at the time of generation. For example, when databases are distributed across multiple regions, the generation unit generates efficient queries. Based on the geographic distribution of databases, the generation unit can generate optimal queries. Furthermore, the generation unit can generate queries that maximize data acquisition efficiency by considering the geographic distribution of databases. By considering the geographic distribution of databases, efficient queries can be generated. Some or all of the above-described processing in the generation unit may be performed using AI, or may be performed without using AI. For example, the generation unit can input database geographic distribution data to a generation AI and have the generation AI generate optimal queries. Specifically, the generation unit periodically collects location information (latitude/longitude, region ID, network latency, bandwidth, node operation status, etc.) from multiple geographically distributed database nodes (e.g., RDBMS or NoSQL clusters located in data centers in Tokyo, Singapore, Frankfurt, etc.). The generation unit normalizes these geographic distribution data using a preprocessing module and inputs them to an AI-based distributed optimization engine (e.g., graph neural network, geographic information clustering model, rule-based+Transformer hybrid model, etc.). The generation unit uses, as AI model inputs, node position vectors (2D or 3D), network parameters (latency, bandwidth, packet loss rate, etc.), data distribution information (replica placement per table, partition key distribution, etc.), and user access location (IP geolocation, device location information, etc.). The AI model outputs, based on this information, query execution plan optimization parameters (e.g., which node to issue queries to, which node to perform JOIN or aggregation processing, subquery partitioning strategies to minimize data transfer, etc.) and query routing rules (e.g., local node priority, distributed aggregation, partial result merging methods, etc.). Example outputs include “Aggregate sales on Tokyo node, extract inventory on Singapore node, integrate results on Frankfurt node,” “Subquery partition: SELECT amount FROM sales WHERE region=‘JP’ on Tokyo,” “Apply LIMIT 100 to minimize network transfer,” and so on. The generation unit reflects the AI model output in SQL query generation templates and distributed query orchestration modules in real time, automatically generating queries optimized for geographically distributed environments. Furthermore, the AI model outputs failover strategies for network load or node failures, and the query generation unit automatically adjusts routing and re-execution parameters. Unlike conventional query generation for single nodes or static routing, the generation unit combines high-dimensional geographic information analysis by AI and dynamic query distribution optimization to realize efficient and reliable query generation in global distributed database environments, which is a technical feature. As a technical effect, the generation unit greatly improves data acquisition latency, reduces network transfer volume, and enhances overall system response speed, availability, and resource efficiency by automatically optimizing queries considering geographic distribution. Application fields include distributed analytics platforms for global enterprises, international financial transaction data warehouses, regionally distributed IoT data collection and analysis, multi-region SaaS services, and all industries and business types requiring geographic distributed data management.

The generation unit improves generation accuracy by referring to related documents at the time of generation. For example, the generation unit refers to related documents and applies optimal query generation methods. The generation unit can also improve generation accuracy based on knowledge obtained from related documents. Furthermore, the generation unit can analyze related documents and apply optimal query generation algorithms. By referring to related documents, generation accuracy can be improved. Some or all of the above-described processing in the generation unit may be performed using AI, or may be performed without using AI. For example, the generation unit can input related document data to a generation AI and have the generation AI improve generation accuracy. Specifically, the generation unit collects and indexes structured and unstructured document data related to query generation, such as technical papers, patent documents, industry standard specifications, and best practice collections (e.g., PDF, HTML, XML, text files, etc.) using a document management module. The generation unit vectorizes these document data using a natural language processing engine (e.g., BERT-based document embedding model, Transformer Encoder, topic modeling, etc.) and inputs them to an AI-based knowledge extraction engine. The generation unit uses, as AI model inputs, user input content (natural language text, token sequence, max length 512), related document embedding vectors (e.g., 768 dimensions), query generation history (2D array), and database schema information (JSON structure), among others. The AI model outputs, based on this information, algorithm knowledge useful for query generation (e.g., optimal JOIN strategies, usage of aggregation functions, index utilization methods, etc.), SQL templates extracted from documents, parameter setting examples, error avoidance measures, and so on. Example outputs include “Recommended algorithm: hash JOIN,” “Reference: Smith et al., 2022,” “SQL template: SELECT . . . GROUP BY . . . HAVING . . . ,” and so on. The generation unit reflects the AI model output in query generation templates and algorithm selection modules in real time, automatically generating high-precision SQL queries utilizing document knowledge. Furthermore, the AI model can extract similar cases and recommended methods from related documents for new business requirements or unknown data structures and automatically apply them to the query generation pipeline. Unlike conventional static template-based generation or manual document reference, the generation unit combines high-dimensional document knowledge extraction by AI and dynamic algorithm application to greatly improve query generation accuracy, versatility, and error tolerance, which is a technical feature. As a technical effect, the generation unit greatly improves adaptability to unknown requirements, generation accuracy, business efficiency, and system reliability by automatically optimizing queries utilizing related documents. Application fields include specialized data extraction in medical, financial, and manufacturing industries, academic research databases, regulatory compliance systems, and industry-standard-compliant analytics platforms, and all industries and business types where document knowledge utilization Is required.

The provision unit estimates the user's emotion and adjusts the display method of the SQL query to be provided based on the estimated user's emotion. For example, if the user is nervous, the provision unit provides a simple and highly visible display method. If the user is relaxed, the provision unit can provide a display method that includes detailed information. Furthermore, if the user is in a hurry, the provision unit can provide a display method that highlights key points. By adjusting the display method of the SQL query according to the user's emotion, a display that is easy for the user to view can be achieved. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the provision unit may be performed using AI, or may be performed without using AI. For example, the provision unit can input the user's emotion data to a generation AI and have the generation AI adjust the display method of the SQL query. Specifically, the provision unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The provision unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., nervousness, relaxation, urgency, etc.) and emotion intensity scores (0.0-1.0). Example outputs include “Nervousness: 0.85,” “Relaxation: 0.15,” “Urgency: 0.92,” and so on. The provision unit uses the AI model output for threshold judgment (e.g., apply simple display if nervousness score is 0.7 or higher) or rule-based branching, and reflects it in the display format selection module in real time. For example, if nervousness is high, UI controls such as “display only the SQL query body,” “highlight important columns,” and “omit explanatory text” are applied;
if relaxed, “add detailed comments,” “visualize query structure,” and “display related data links” are applied; if in a hurry, “highlight only key points” and “display the execute button larger” are applied. The AI model output is structured as display format labels (e.g., “simple,” “detailed,” “summary”) and display parameters (e.g., highlighted columns, presence of comments, layout settings, etc.). Unlike conventional static displays or uniform UIs, the provision unit combines high-dimensional emotion estimation by AI and dynamic display control to realize SQL query display optimized for the user's state, which is a technical feature. As a technical effect, the provision unit greatly improves query comprehension, operation efficiency, user satisfaction, and overall business productivity by automatically generating optimal displays according to the user's real-time emotional state. Application fields include management analysis dashboards for enterprises, medical data extraction UIs, financial transaction analysis tools, sales support systems, and SQL learning support in education, and all industries and business types where display optimization according to user state is required.

The provision unit selects the optimal display method by referring to the user's past query execution history at the time of provision. For example, based on display methods previously used by the user, the provision unit proposes the optimal display method. The provision unit can also select the optimal display method from the user's past query execution history. Furthermore, by analyzing the user's past display history, the provision unit can propose the optimal display method. By referring to the user's past query execution history, the optimal display method can be selected. Some or all of the above-described processing in the provision unit may be performed using AI, or may be performed without using AI. For example, the provision unit can input the user's past query execution history data to a generation AI and have the generation AI select the optimal display method. Specifically, the provision unit refers to a query execution history database recorded in chronological order for each user (e.g., NoSQL type, RDBMS type, with metadata such as query issue date/time, query content, display format, device type, user operation log, etc. attached to each record). The provision unit extracts history data as a time-series array (e.g., up to 100 items per day for the past 90 days, 2D array), normalizes, removes duplicates, and extracts features (e.g., display format frequency, time-of-day display trends, display optimization history per device, etc.) using a preprocessing module. An AI-based history analysis engine (e.g., time-series RNN, Transformer Encoder, clustering algorithm, etc.) uses these features as input to generate a display trend model for each user. Example AI model inputs include query content token sequence (max length 512), display format category (one-hot vector: table, bar_chart, pie_chart, etc.), display time (24-hour format), device type (smartphone, PC, etc.), and user operation log (number of clicks, number of filter applications, etc.). The AI model outputs, based on this information, the display format most likely to be used at the next query execution (e.g., graph, table, heatmap, etc.), display parameters (e.g., X-axis/Y-axis column specification, color category, etc.), and user-specific customization settings (e.g., font size, color theme, etc.) as probability distributions or score lists. Example outputs include “bar_chart: 0.7, table: 0.2, pie_chart: 0.1,” “X-axis: year, Y-axis: amount,” “Theme: dark,” and so on. The provision unit sorts the AI model output by threshold judgment or ranking and automatically reflects it in the display UI generation module. Furthermore, display formats frequently used by the user at specific times or on specific devices are preferentially suggested, optimizing display content and improving user experience. Unlike conventional static history list displays or uniform template application, the provision unit combines high-dimensional feature extraction and time-series prediction by AI to propose and apply display methods and content optimized for each user in real time, which is a technical feature. As a technical effect, the provision unit greatly improves display efficiency, business speed, and user satisfaction by learning the user's display trends and automatically presenting and applying optimal display methods and content. Application fields include sales support dashboards, medical data visualization, financial transaction analysis, customer support chat, IoT device management, and all industries and business types where display trends differ for each user.

The provision unit applies different display algorithms according to the user's business content at the time of provision. For example, when the user is engaged in sales operations, the provision unit provides display methods specialized for sales data. In addition, when the user is engaged in inventory management operations, the provision unit can provide display methods specialized for inventory data. Furthermore, the provision unit can apply the optimal display algorithm according to the user's business content. By applying the optimal display algorithm according to the user's business content, displays suitable for the business can be provided. Some or all of the above-described processing in the provision unit may be performed using AI, or may be performed without using AI. For example, the provision unit can input the user's business content data to a generation AI and have the generation AI apply the optimal display algorithm. Specifically, the provision unit normalizes and extracts features from business content data (e.g., business type, ongoing tasks, business flow status, business attribute codes, etc.) obtained from the user's business process management system or business applications using a preprocessing module, and inputs them to an AI-based business content analysis engine (e.g., rule-based+neural network, business-specialized Transformer, etc.). The provision unit uses, as AI model inputs, business type (one-hot vector), task progress (numeric scalar), business flow status (token sequence), business attributes (category vector), and user attribute information (e.g., position, department, etc.), among others. The AI model outputs, based on this information, the optimal display algorithm (e.g., sales business graph template, inventory management heatmap, accounting business pivot table, etc.) and display parameters (e.g., aggregation granularity, period specification method, highlighted columns, etc.). Example outputs include “Sales business: bar_chart (year, amount),” “Inventory management: heatmap (product, stock_level),” “Accounting business: pivot_table (account, period),” and so on. The provision unit automatically switches the display UI generation pipeline and template selection module based on the AI model output, generating displays optimized for the business content. Furthermore, the AI model can handle changes in business content and simultaneous progress of multiple businesses, enabling combinations of multiple templates and dynamic parameter adjustments. Unlike conventional static display templates or manual business switching, the provision unit combines high-dimensional business content analysis by AI and dynamic algorithm selection to realize display generation optimized for business status, which is a technical feature. As a technical effect, the provision unit greatly improves business efficiency, data comprehension, user satisfaction, and overall business productivity by automatically optimizing displays according to business content. Application fields include process management dashboards in manufacturing sites, visualization of medical records in medical sites, transaction analysis in financial operations, sales support systems, and all industries and business types where display optimization according to business content is required.

The provision unit estimates the user's emotion and determines the priority of SQL queries to be provided based on the estimated user's emotion. For example, if the user is feeling stressed, the provision unit prioritizes the provision of important queries. If the user is relaxed, the provision unit can prioritize the provision of detailed queries. Furthermore, if the user is in a hurry, the provision unit can prioritize the provision of queries that can be provided quickly. By determining the priority of SQL queries according to the user's emotion, important queries can be provided preferentially. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the provision unit may be performed using AI, or may be performed without using AI. For example, the provision unit can input the user's emotion data to a generation AI and have the generation AI determine the priority of SQL queries. Specifically, the provision unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The provision unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., stress, relaxation, urgency, etc.) and emotion intensity scores (0.0-1.0). Example outputs include “Stress: 0.85,” “Relaxation: 0.15,” “Urgency: 0.92,” and so on. The provision unit uses the AI model output for threshold judgment (e.g., prioritize important queries if stress score is 0.7 or higher) or rule-based branching, and reflects it in the query display priority decision module in real time. For example, if stress is high, essential queries such as “sales data extraction” are displayed preferentially; if relaxed, “detailed analysis queries” and “auxiliary information extraction queries” are also prioritized for display; if in a hurry, “execution speed-focused queries” and “partial extraction queries” are prioritized for display. The AI model output is structured as a query priority list (e.g., a list with priority scores for each query). For example, “Sales extraction: 1.0, Inventory analysis: 0.8, Detailed analysis: 0.5,” and so on. The provision unit automatically controls the query display pipeline and template selection module based on these priorities, realizing query display optimized for the user's state. Unlike conventional uniform query display or static priority settings, the provision unit combines high-dimensional emotion estimation by AI and dynamic priority control to realize a query display flow optimized for the user's state, which is a technical feature. As a technical effect, the provision unit greatly improves query display efficiency, business speed, and user satisfaction by prioritizing important items and optimizing display procedures. Application fields include medical interview systems, financial transaction terminals, sales support tools, customer support chat, and all industries and business types where query display priority control according to user state is required.

The provision unit selects the optimal display method by considering the user's geographic location information at the time of provision. For example, when the user is in a specific region, the provision unit provides a display method suitable for that region. Based on the user's geographic location information, the provision unit can select the optimal display method. Furthermore, when the user moves to a different region, the provision unit can automatically switch to a display method suitable for that region. By considering the user's geographic location information, the optimal display method can be selected. Some or all of the above-described processing in the provision unit may be performed using AI, or may be performed without using AI. For example, the provision unit can input the user's geographic location information data to a generation AI and have the generation AI select the optimal display method. Specifically, the provision unit obtains geographic location data (latitude/longitude, country/region code, city name, etc.) from the user's device GPS, IP address, Wi-Fi location information, etc., and normalizes and extracts features using a preprocessing module. The provision unit inputs latitude/longitude vectors (2D), country code (one-hot vector), city name (token sequence), and user attribute information to an AI-based region identification engine (e.g., geographic information clustering model, rule-based+neural network). The AI model outputs, based on this information, region-specific display formats (e.g., date format “YYYY/MM/DD” or “MM-DD-YYYY,” currency unit “yen” or “dollar,” address display order, language settings, etc.) and display options (e.g., region-limited graph types, local business terminology, etc.). Example outputs include “Date format: YYYY/MM/DD,” “Currency: yen,” “Graph type: bar_chart,” “Language: Japanese,” and so on. The provision unit reflects the AI model output in the display UI generation module, enabling the user to view data in the optimal display format for the region. Furthermore, when the user moves to a different region, the change in location information triggers automatic switching of the display format. Unlike conventional static region settings or manual switching, the provision unit combines high-dimensional location information analysis by AI and dynamic UI generation to automate region-specific display optimization, which is a technical feature. As a technical effect, the provision unit greatly reduces display errors, business mistakes, and user burden, and realizes efficient global deployment and multi-location operation by automatically applying display formats suited to regional business requirements, regulations, and user habits. Application fields include business systems for international companies, global e-commerce sites, multi-region UI for medical, financial, and logistics industries, and all industries and business types where region-specific display optimization is required.

The provision unit improves display accuracy by referring to related documents at the time of provision. For example, the provision unit refers to related documents and applies optimal display methods. The provision unit can also improve display accuracy based on knowledge obtained from related documents. Furthermore, the provision unit can analyze related documents and apply optimal display algorithms. By referring to related documents, display accuracy can be improved. Some or all of the above-described processing in the provision unit may be performed using AI, or may be performed without using AI. For example, the provision unit can input related document data to a generation AI and have the generation AI improve display accuracy. Specifically, the provision unit collects and indexes structured and unstructured document data related to display optimization, such as technical papers, patent documents, industry standard specifications, and best practice collections (e.g., PDF, HTML, XML, text files, etc.) using a document management module. The provision unit vectorizes these document data using a natural language processing engine (e.g., BERT-based document embedding model, Transformer Encoder, topic modeling, etc.) and inputs them to an AI-based knowledge extraction engine. The provision unit uses, as AI model inputs, user display requirements (natural language text, token sequence, max length 512), related document embedding vectors (e.g., 768 dimensions), past display history (2D array), and database schema information (JSON structure), among others. The AI model outputs, based on this information, algorithm knowledge useful for display optimization (e.g., optimal graph type selection, color vision barrier-free color schemes, interaction design, etc.), display templates extracted from documents, parameter setting examples, error avoidance measures, and so on. Example outputs include “Recommended algorithm: heatmap,” “Reference: Tanaka et al., 2021,” “Display template: bar_chart (year, amount),” and so on. The provision unit reflects the AI model output in display templates and algorithm selection modules in real time, automatically generating high-precision displays utilizing document knowledge. Furthermore, the AI model can extract similar cases and recommended methods from related documents for new business requirements or unknown data structures and automatically apply them to the display generation pipeline. Unlike conventional static template-based display or manual document reference, the provision unit combines high-dimensional document knowledge extraction by AI and dynamic algorithm application to greatly improve display accuracy, versatility, and error tolerance, which is a technical feature. As a technical effect, the provision unit greatly improves adaptability to unknown requirements, display accuracy, business efficiency, and system reliability by automatically optimizing displays utilizing related documents. Application fields include specialized data visualization in medical, financial, and manufacturing industries, academic research dashboards, regulatory compliance systems, and industry-standard-compliant analytics platforms, and all industries and business types where document knowledge utilization is required.

The update unit estimates the user's emotion and adjusts the timing of updates based on the estimated user's emotion. For example, if the user is feeling stressed, the update unit reduces the frequency of updates and performs only important updates. If the user is relaxed, the update unit can perform detailed updates frequently. Furthermore, if the user is in a hurry, the update unit can perform updates quickly. By adjusting the timing of updates according to the user's emotion, updates can be performed at the optimal timing for the user. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the update unit may be performed using AI, or may be performed without using AI. For example, the update unit can input the user's emotion data to a generation AI and have the generation AI adjust the timing of updates. Specifically, the update unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The update unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., stress, relaxation, urgency, etc.) and emotion intensity scores (0.0-1.0). Example outputs include “Stress: 0.85,” “Relaxation: 0.15,” “Urgency: 0.92,” and so on. The update unit uses the AI model output for threshold judgment (e.g., reduce update frequency if stress score is 0.7 or higher) or rule-based branching, and reflects it in the update scheduler or trigger control module in real time. For example, if stress is high, controls such as “immediate update of important items only” and “extend regular update intervals” are applied; if relaxed, “frequent updates of detailed items” and “real-time synchronization” are applied; if in a hurry, “immediate update” and “omit batch updates” are applied. The AI model output is structured as update timing parameters (e.g., update interval, immediate update flag, batch update presence, etc.). Unlike conventional static update schedules or uniform timing settings, the update unit combines high-dimensional emotion estimation by AI and dynamic timing control to realize an update flow optimized for the user's state, which is a technical feature. As a technical effect, the update unit greatly improves overall system operation efficiency, user experience, and business continuity by automatically determining the optimal update timing according to the user's real-time emotional state. Application fields include patient information updates in medical interview systems, real-time data synchronization in financial transaction terminals, business progress updates in sales support systems, and all industries and business types where update timing optimization according to user state is required.

The update unit selects the optimal update method by referring to past update history at the time of update. For example, the update unit proposes the optimal update method based on past update history. The update unit can also select the optimal update timing from past update history. Furthermore, by analyzing past update history, the update unit can propose the optimal update method. By referring to past update history, the optimal update method can be selected. Some or all of the above-described processing in the update unit may be performed using AI, or may be performed without using AI. For example, the update unit can input past update history data to a generation AI and have the generation AI select the optimal update method. Specifically, the update unit refers to an update history database recorded in chronological order for each user or system (e.g., NoSQL type, RDBMS type, with metadata such as update date/time, target table, update content, update means, device type, update result status, etc. attached to each record). The update unit extracts history data as a time-series array (e.g., up to 200 items per day for the past 180 days, 2D array), normalizes, removes duplicates, and extracts features (e.g., update frequency, distribution of update means, time-of-day trends, error occurrence rate, etc.) using a preprocessing module. An AI-based history analysis engine (e.g., time-series RNN, Transformer Encoder, clustering algorithm, etc.) uses these features as input to generate an optimal update trend model for each user or system. Example AI model inputs include update content token sequence (max length 256), update means category (one-hot vector), update time (24-hour format), device type (smartphone, PC, etc.), and update result (success/failure label). The AI model outputs, based on this information, the update means with the highest success rate at the next update (e.g., batch update, real-time update, partial update, etc.), recommended update timing (e.g., late night, after business hours, etc.), and recommended update granularity (e.g., full update, differential update, etc.) as probability distributions or score lists. Example outputs include “Batch update: 0.8, real-time update: 0.2,” “Recommended timing: 23:00,” “Recommended granularity: differential,” and so on. The update unit sorts the AI model output by threshold judgment or ranking and automatically reflects it in the update method selection module or scheduler. Furthermore, if errors have frequently occurred at specific times or with specific means in the past, those conditions are automatically avoided, and highly reliable update methods are preferentially proposed and applied. Unlike conventional static history list reference or uniform update schedules, the update unit combines high-dimensional feature extraction and time-series prediction by AI to realize automatic selection of update methods and timing optimized for each user or system, which is a technical feature. As a technical effect, the update unit greatly improves update accuracy, business speed, system stability, and user satisfaction by learning past update trends and success/failure rates and automatically presenting and applying optimal update methods and timing. Application fields include data synchronization in sales support systems, patient information updates in medical information systems, history data updates in financial transaction terminals, firmware updates in IoT device management, and all industries and business types where update trends differ for each user or system.

The update unit estimates the user's emotion and determines the priority of updates based on the estimated user's emotion. For example, if the user is feeling stressed, the update unit prioritizes important updates. If the user is relaxed, the update unit can prioritize detailed updates. Furthermore, if the user is in a hurry, the update unit can prioritize updates that can be performed quickly. By determining the priority of updates according to the user's emotion, important updates can be performed preferentially. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the update unit may be performed using AI, or may be performed without using AI. For example, the update unit can input the user's emotion data to a generation AI and have the generation AI determine the priority of updates. Specifically, the update unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The update unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., stress, relaxation, urgency, etc.) and emotion intensity scores (0.0-1.0). Example outputs include “Stress: 0.85,” “Relaxation: 0.15,” “Urgency: 0.92,” and so on. The update unit uses the AI model output for threshold judgment (e.g., prioritize important updates if stress score is 0.7 or higher) or rule-based branching, and reflects it in the update priority decision module in real time. For example, if stress is high, “priority update of essential items and main conditions” is performed; if relaxed, “priority update of detailed items and auxiliary information” is performed; if in a hurry, “priority update of updates that can be applied immediately with emphasis on update speed” is performed. The AI model output is structured as an update priority list (e.g., a list with priority scores for each update item). For example, “User information: 1.0, Business progress: 0.9, Operation log: 0.7, Auxiliary information: 0.3,” and so on. The update unit updates high-priority data from the database or storage first based on these priorities, and low-priority data is postponed or omitted. Unlike conventional uniform updates or static priority settings, the update unit combines high-dimensional emotion estimation by AI and dynamic priority control to realize an update flow optimized for the user's state, which is a technical feature. As a technical effect, the update unit greatly improves update efficiency, business speed, and user satisfaction by prioritizing important items and optimizing update procedures. Application fields include medical interview systems, financial transaction terminals, sales support tools, customer support chat, and all industries and business types where update priority control according to user state is required.

The update unit selects the optimal update method by considering the geographic distribution of databases at the time of update. For example, when databases are distributed across multiple regions, the update unit selects efficient update methods. Based on the geographic distribution of databases, the update unit can select the optimal update method. Furthermore, the update unit can select methods that maximize data update efficiency by considering the geographic distribution of databases. By considering the geographic distribution of databases, efficient update methods can be selected. Some or all of the above-described processing in the update unit may be performed using AI, or may be performed without using AI. For example, the update unit can input database geographic distribution data to a generation AI and have the generation AI select the optimal update method. Specifically, the update unit periodically collects location information (latitude/longitude, region ID, network latency, bandwidth, node operation status, etc.) from multiple geographically distributed database nodes (e.g., RDBMS or NoSQL clusters located in data centers in Tokyo, Singapore, Frankfurt, etc.). The update unit normalizes these geographic distribution data using a preprocessing module and inputs them to an AI-based distributed optimization engine (e.g., graph neural network, geographic information clustering model, rule-based+Transformer hybrid model, etc.). The update unit uses, as AI model inputs, node position vectors (2D or 3D), network parameters (latency, bandwidth, packet loss rate, etc.), data distribution information (replica placement per table, partition key distribution, etc.), and attributes of the data to be updated (e.g., update size, update frequency, consistency requirements, etc.). The AI model outputs, based on this information, update execution plan optimization parameters (e.g., which node to issue updates to, whether to use distributed transactions, sub-update partitioning strategies to minimize data transfer, etc.) and update routing rules (e.g., local node priority, distributed update, partial result merging methods, etc.). Example outputs include “Update main data on Tokyo node, update auxiliary data on Singapore node, integrate results on Frankfurt node,” “Sub-update partition: UPDATE sales SET amount=. . . WHERE region=‘JP’ on Tokyo,” “Apply batch update to minimize network transfer,” and so on. The update unit reflects the AI model output in update execution templates and distributed update orchestration modules in real time, automatically executing updates optimized for geographically distributed environments. Furthermore, the AI model outputs failover strategies for network load or node failures, and the update unit automatically adjusts routing and re-execution parameters. Unlike conventional updates for single nodes or static routing, the update unit combines high-dimensional geographic information analysis by AI and dynamic distributed update optimization to realize efficient and reliable updates in global distributed database environments, which is a technical feature. As a technical effect, the update unit greatly improves data synchronization latency, reduces network transfer volume, and enhances overall system response speed, availability, and resource efficiency by automatically optimizing updates considering geographic distribution. Application fields include distributed data synchronization for global enterprises, international financial transaction data warehouses, regionally distributed IoT data updates, multi-region SaaS services, and all industries and business types requiring geographic distributed data management.

The customization unit estimates the user's emotion and adjusts the content of customization based on the estimated user's emotion. For example, if the user is feeling stressed, the customization unit provides simple and intuitive customization options. If the user is relaxed, the customization unit can provide detailed customization options. Furthermore, if the user is in a hurry, the customization unit can provide options that allow rapid customization. By adjusting the content of customization according to the user's emotion, optimal customization can be provided to the user. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the customization unit may be performed using AI, or may be performed without using AI. For example, the customization unit can input the user's emotion data to a generation AI and have the generation AI adjust the content of customization. Specifically, the customization unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The customization unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., stress, relaxation, urgency, etc.) and emotion intensity scores (0.0-1.0). Example outputs include “Stress: 0.85,” “Relaxation: 0.15,” “Urgency: 0.92,” and so on. The customization unit uses the AI model output for threshold judgment (e.g., apply simple options if stress score is 0.7 or higher) or rule-based branching, and reflects it in the customization UI generation module or option selection module in real time. For example, if stress is high, UI controls such as “display only main functions,” “hide detailed settings,” and “one-click application” are applied; if relaxed, “expand detailed settings,” “add customization items,” and “display advanced options” are applied; if in a hurry, “apply presets immediately” and “display only minimal choices” are applied. The AI model output is structured as customization content parameters (e.g., display item list, detail score, applied template, etc.). Unlike conventional static customization UIs or uniform option displays, the customization unit combines high-dimensional emotion estimation by AI and dynamic UI control to realize customization content generation optimized for the user's state, which is a technical feature. As a technical effect, the customization unit greatly improves customization efficiency, operability, user satisfaction, and overall business productivity by automatically generating optimal customization content according to the user's real-time emotional state. Application fields include UI customization for business support tools, personalization of business screens in medical, financial, and manufacturing industries, learning support UIs in education, and all industries and business types where customization optimization according to user state is required.

The customization unit selects the optimal customization method by referring to the user's past customization history at the time of customization. For example, the customization unit proposes the optimal customization method based on the user's past customization history. The customization unit can also select the optimal customization option from the user's past customization history. Furthermore, by analyzing the user's past customization history, the customization unit can propose the optimal customization method. By referring to the user's past customization history, the optimal customization method can be selected. Some or all of the above-described processing in the customization unit may be performed using AI, or may be performed without using AI. For example, the customization unit can input the user's past customization history data to a generation AI and have the generation AI select the optimal customization method. Specifically, the customization unit refers to a customization history database recorded in chronological order for each user (e.g., NoSQL type, RDBMS type, with metadata such as customization date/time, customization content, selected options, applied template, device type, user operation log, etc. attached to each record). The customization unit extracts history data as a time-series array (e.g., up to 100 items per day for the past 180 days, 2D array), normalizes, removes duplicates, and extracts features (e.g., customization frequency, option selection trends, time-of-day customization trends, customization history per device, etc.) using a preprocessing module. An AI-based history analysis engine (e.g., time-series RNN, Transformer Encoder, clustering algorithm, etc.) uses these features as input to generate a customization trend model for each user. Example AI model inputs include customization content token sequence (max length 256), option category (one-hot vector), customization time (24-hour format), device type (smartphone, PC, etc.), and user operation log (number of clicks, number of applications, etc.). The AI model outputs, based on this information, the customization method most likely to be used at the next customization (e.g., preset application, detailed setting expansion, one-click application, etc.), customization parameters (e.g., display item list, detail score, applied template, etc.), and user-specific customization settings (e.g., color theme, layout pattern, etc.) as probability distributions or score lists. Example outputs include “Preset application: 0.7, detailed setting: 0.2, one-click: 0.1,” “Theme: dark,” “Layout: compact,” and so on. The customization unit sorts the AI model output by threshold judgment or ranking and automatically reflects it in the customization UI generation module or option selection module. Furthermore, customization methods frequently used by the user at specific times or on specific devices are preferentially suggested, optimizing customization content and improving user experience. Unlike conventional static history list reference or uniform template application, the customization unit combines high-dimensional feature extraction and time-series prediction by AI to propose and apply customization methods and content optimized for each user in real time, which is a technical feature. As a technical effect, the customization unit greatly improves customization efficiency, business speed, and user satisfaction by learning the user's customization trends and automatically presenting and applying optimal customization methods and content. Application fields include UI customization for sales support tools, personalization of business screens in medical, financial, and manufacturing industries, learning support UIs in education, and all industries and business types where customization trends differ for each user.

The customization unit estimates the user's emotion and determines the priority of customization based on the estimated user's emotion. For example, if the user is feeling stressed, the customization unit prioritizes important customization. If the user is relaxed, the customization unit can prioritize detailed customization. Furthermore, if the user is in a hurry, the customization unit can prioritize options that allow rapid customization. By determining the priority of customization according to the user's emotion, important customization can be performed preferentially. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the customization unit may be performed using AI, or may be performed without using AI. For example, the customization unit can input the user's emotion data to a generation AI and have the generation AI determine the priority of customization. Specifically, the customization unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The customization unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., stress, relaxation, urgency, etc.) and emotion intensity scores (0.0-1.0). Example outputs include “Stress: 0.85,” “Relaxation: 0.15,” “Urgency: 0.92,” and so on. The customization unit uses the AI model output for threshold judgment (e.g., prioritize important customization if stress score is 0.7 or higher) or rule-based branching, and reflects it in the customization priority decision module in real time. For example, if stress is high, “priority customization of main functions and essential items” is performed; if relaxed, “priority customization of detailed settings and auxiliary options” is performed; if in a hurry, “priority customization of presets and one-click customization that can be applied immediately” is performed. The AI model output is structured as a customization priority list (e.g., a list with priority scores for each customization item). For example, “Theme change: 1.0, Layout adjustment: 0.8, Detailed settings: 0.5,” and so on. The customization unit automatically controls the customization UI generation module and option selection module based on these priorities, realizing a customization flow optimized for the user's state. Unlike conventional uniform customization or static priority settings, the customization unit combines high-dimensional emotion estimation by AI and dynamic priority control to realize a customization flow optimized for the user's state, which is a technical feature. As a technical effect, the customization unit greatly improves customization efficiency, business speed, and user satisfaction by prioritizing important items and optimizing customization procedures. Application fields include screen customization in medical interview systems, UI personalization in financial transaction terminals, function customization in sales support tools, customer support chat, and all industries and business types where customization priority control according to user state is required.

The customization unit selects the optimal customization method by considering the user's geographic location information at the time of customization. For example, when the user is in a specific region, the customization unit provides customization options suitable for that region. Based on the user's geographic location information, the customization unit can select the optimal customization method. Furthermore, when the user moves to a different region, the customization unit can automatically switch to customization options suitable for that region. By considering the user's geographic location information, the optimal customization method can be selected. Some or all of the above-described processing in the customization unit may be performed using AI, or may be performed without using AI. For example, the customization unit can input the user's geographic location information data to a generation AI and have the generation AI select the optimal customization method. Specifically, the customization unit obtains geographic location data (latitude/longitude, country/region code, city name, etc.) from the user's device GPS, IP address, Wi-Fi location information, etc., and normalizes and extracts features using a preprocessing module. The customization unit inputs latitude/longitude vectors (2D), country code (one-hot vector), city name (token sequence), and user attribute information to an AI-based region identification engine (e.g., geographic information clustering model, rule-based+neural network). The AI model outputs, based on this information, region-specific customization options (e.g., local language UI, region-limited themes, local business terminology, currency unit, date format, etc.) and customization priority scores. Example outputs include “Theme: Japanese style,” “Language: Japanese,” “Currency: yen,” “Date format: YYYY/MM/DD,” and so on. The customization unit reflects the AI model output in the customization UI generation module and option selection module, presenting optimal customization content according to the region to the user. Furthermore, when the user moves to a different region, the change in location information triggers automatic switching of customization content. The AI model output is structured as a customization content list (option list per region, with priority scores). For example, “Region: Tokyo, Theme: Japanese style, Language: Japanese, Priority: 0.95,” and so on. Unlike conventional static region settings or manual switching, the customization unit combines high-dimensional location information analysis by AI and dynamic customization optimization to automate region-specific customization, which is a technical feature. As a technical effect, the customization unit greatly reduces customization errors, business mistakes, and user burden, and realizes efficient global deployment and multi-location operation by automatically applying customization content suited to regional business requirements, regulations, and user habits. Application fields include business systems for international companies, global e-commerce sites, multi-region UI customization for medical, financial, and logistics industries, and all industries and business types where region-specific customization optimization is required.

The display unit estimates the user's emotion and adjusts the display method based on the estimated user's emotion. For example, if the user is nervous, the display unit provides a simple and highly visible display method. If the user is relaxed, the display unit can provide a display method that includes detailed information. Furthermore, if the user is in a hurry, the display unit can provide a display method that highlights key points. By adjusting the display method according to the user's emotion, a display that is easy for the user to view can be achieved. Emotion estimation may be realized using, for example, an emotion engine or a generation AI with emotion estimation functions. The generation AI may be a text generation AI (e.g., LLM) or a multimodal generation AI, but is not limited thereto. Some or all of the above-described processing in the display unit may be performed using AI, or may be performed without using AI. For example, the display unit can input the user's emotion data to a generation AI and have the generation AI adjust the display method. Specifically, the display unit normalizes and extracts features from emotion-related data (e.g., natural language text, audio waveforms, facial images, biometric sensor values, etc.) obtained from the user's input interface or sensor devices using a preprocessing module, and inputs them to an AI-based emotion estimation engine such as a multimodal Transformer or CNN+RNN hybrid model. The display unit uses, as AI model inputs, natural language text (token sequence, max length 256), audio spectrogram (128×1000), facial image feature map (64×64×128), and biometric signal vector (length 100), among others. The AI model integrates these features and outputs emotion categories (e.g., nervousness, relaxation, urgency, etc.) and emotion intensity scores (0.0-1.0). Example outputs include “Nervousness: 0.85,” “Relaxation: 0.15,” “Urgency: 0.92,” and so on. The display unit uses the AI model output for threshold judgment (e.g., apply simple display if nervousness score is 0.7 or higher) or rule-based branching, and reflects it in the display format selection module in real time. For example, if nervousness is high, controls such as “highlight only main information,” “omit explanatory text,” and “simplify UI elements” are applied; if relaxed, “add detailed comments,” “visualize data structure,” and “display related information links” are applied; if in a hurry, “highlight only key points” and “display the execute button larger” are applied. The AI model output is structured as display format labels (e.g., “simple,” “detailed,” “summary”) and display parameters (e.g., highlighted columns, presence of comments, layout settings, etc.). Unlike conventional static displays or uniform UIs, the display unit combines high-dimensional emotion estimation by AI and dynamic display control to realize display generation optimized for the user's state, which is a technical feature. As a technical effect, the display unit greatly improves data comprehension, operation efficiency, user satisfaction, and overall business productivity by automatically generating optimal displays according to the user's real-time emotional state. Application fields include management analysis dashboards for enterprises, medical data visualization UIs, financial transaction analysis tools, sales support systems, and learning support UIs in education, and all industries and business types where display optimization according to user state is required.

The display unit selects the optimal display method by referring to the user's past display history at the time of display. For example, based on display methods previously used by the user, the display unit proposes the optimal display method. The display unit can also select the optimal display method from the user's past display history. Furthermore, by analyzing the user's past display history, the display unit can propose the optimal display method. By referring to the user's past display history, the optimal display method can be selected. Some or all of the above-described processing in the display unit may be performed using AI, or may be performed without using AI. For example, the display unit can input the user's past display history data to a generation AI and have the generation AI select the optimal display method.

A display unit estimates a user's emotion and determines a display priority based on the estimated user's emotion. The display unit estimates a user's emotion and determines a display priority based on the estimated user's emotion. For example, when the user is feeling stressed, the display unit preferentially displays important information. When the user is relaxed, the display unit can preferentially display detailed information. Furthermore, when the user is in a hurry, the display unit can also preferentially display information that can be displayed quickly. By determining the display priority according to the user's emotion, important information can be preferentially displayed. Emotion estimation is realized, for example, by using an emotion estimation function such as an emotion engine or generative AI. The generative AI may be a text generative AI (for example, LLM) or a multimodal generative AI, but is not limited to such examples. Some or all of the above-described processing in the display unit may be performed using AI, or may be performed without using AI. For example, the display unit may input the user's emotion data to generative AI and have the generative AI determine the display priority.

A display unit selects an optimal display method by considering the user's device information at the time of display. The display unit selects an optimal display method by considering the user's device information at the time of display. For example, when the user is using a smartphone, the display unit provides a display method adapted to the screen size. When the user is using a tablet, the display unit can provide a display method optimized for a larger screen. Furthermore, when the user is using a smartwatch, the display unit can also provide a concise and highly visible display method. By considering the user's device information, an optimal display method can be selected. Some or all of the above-described processing in the display unit may be performed using AI, or may be performed without using AI. For example, the display unit may input the user's device information data to generative AI and have the generative AI select the optimal display method.

The system according to the embodiment is not limited to the above-described examples, and various modifications are possible, for example, as follows.

A reception unit can automatically search for related past data based on the user's input content and present it to the user. For example, when the user inputs “I want to extract sales data for 2023,” the reception unit searches for past sales data and presents related data to the user. When the user inputs specific conditions, the reception unit can search for past data based on those conditions and present it to the user. Furthermore, the reception unit can also automatically search for related data based on the user's input content and present it to the user. Thus, the user can efficiently extract data while referring to past data.

A generation unit can automatically search for related data based on the user's input content and generate an optimal SQL query. For example, when the user inputs “I want to extract sales data for 2023,” the generation unit searches for past sales data and generates an optimal SQL query based on the related data. When the user inputs specific conditions, the generation unit can search for related data based on those conditions and generate an optimal SQL query. Furthermore, the generation unit can also automatically search for related data based on the user's input content and generate an optimal SQL query. Thus, the generation unit can efficiently generate an optimal SQL query based on the user's input content.

A provision unit, when providing the execution result of a generated SQL query to the user, can automatically search for related data and present it to the user. For example, when the user inputs “I want to extract sales data for 2023,” the provision unit searches for past sales data and presents related data to the user. When the user inputs specific conditions, the provision unit can search for related data based on those conditions and present it to the user. Furthermore, the provision unit can also automatically search for related data based on the user's input content and present it to the user. Thus, by providing related data to the user, the provision unit can efficiently extract data.

A reception unit can automatically search for related data based on the user's input content and present it to the user. For example, when the user inputs “I want to extract sales data for 2023,” the reception unit searches for past sales data and presents related data to the user. When the user inputs specific conditions, the reception unit can search for related data based on those conditions and present it to the user. Furthermore, the reception unit can also automatically search for related data based on the user's input content and present it to the user. Thus, by providing related data to the user, the reception unit can efficiently extract data.

A reception unit can automatically search for related data based on the user's input content and present it to the user. For example, when the user inputs “I want to extract sales data for 2023,” the reception unit searches for past sales data and presents related data to the user. When the user inputs specific conditions, the reception unit can search for related data based on those conditions and present it to the user. Furthermore, the reception unit can also automatically search for related data based on the user's input content and present it to the user. Thus, by providing related data to the user, the reception unit can efficiently extract data.

A reception unit estimates a user's emotion and changes a design of an input interface in real time based on the estimated user's emotion. For example, when the user is feeling stressed, the reception unit provides a simple and intuitive interface and minimizes input steps. When the user is relaxed, the reception unit can provide detailed input options and propose customizable input methods. Furthermore, when the user is in a hurry, the reception unit prioritizes voice input to enable rapid entry of data extraction conditions. By changing the design of the input interface according to the user's emotion, the user's input experience can be improved.

A reception unit estimates a user's emotion and changes a design of an input interface in real time based on the estimated user's emotion. For example, when the user is feeling stressed, the reception unit provides a simple and intuitive interface and minimizes input steps. When the user is relaxed, the reception unit can provide detailed input options and propose customizable input methods. Furthermore, when the user is in a hurry, the reception unit prioritizes voice input to enable rapid entry of data extraction conditions. By changing the design of the input interface according to the user's emotion, the user's input experience can be improved.

A reception unit estimates a user's emotion and changes a design of an input interface in real time based on the estimated user's emotion. For example, when the user is feeling stressed, the reception unit provides a simple and intuitive interface and minimizes input steps. When the user is relaxed, the reception unit can provide detailed input options and propose customizable input methods. Furthermore, when the user is in a hurry, the reception unit prioritizes voice input to enable rapid entry of data extraction conditions. By changing the design of the input interface according to the user's emotion, the user's input experience can be improved.

A reception unit estimates a user's emotion and changes a design of an input interface in real time based on the estimated user's emotion. For example, when the user is feeling stressed, the reception unit provides a simple and intuitive interface and minimizes input steps. When the user is relaxed, the reception unit can provide detailed input options and propose customizable input methods. Furthermore, when the user is in a hurry, the reception unit prioritizes voice input to enable rapid entry of data extraction conditions. By changing the design of the input interface according to the user's emotion, the user's input experience can be improved.

A reception unit estimates a user's emotion and changes a design of an input interface in real time based on the estimated user's emotion. For example, when the user is feeling stressed, the reception unit provides a simple and intuitive interface and minimizes input steps. When the user is relaxed, the reception unit can provide detailed input options and propose customizable input methods. Furthermore, when the user is in a hurry, the reception unit prioritizes voice input to enable rapid entry of data extraction conditions. By changing the design of the input interface according to the user's emotion, the user's input experience can be improved.

The processing flow of Example of the Embodiment will be briefly described below.
Step 1: A reception unit receives user input. The user input includes text input, voice input, image input, and the like. The reception unit receives user input, for example, in a chat format.
Step 2: A collection unit collects input content received by the reception unit. The collection unit, for example, stores the user's input content in a database. The collection unit can also organize data based on the format of the input content and the timing of collection.
Step 3: A generation unit generates an SQL query based on the input content collected by the collection unit. The generation unit, for example, uses AI to analyze the user's input content and generate an optimal SQL query. The generation unit creates an accurate SQL query based on the structure of the database and mart definitions.
Step 4: A provision unit provides the SQL query generated by the generation unit. The provision unit, for example, displays the generated SQL query to the user. The provision unit can also execute the generated SQL query on the database and provide the result to the user.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned reception unit, collection unit, generation unit, and provision unit is implemented by at least one of, for example, the smart device 14 and the data processing apparatus 12. For example, the reception unit is implemented by a control unit 46A of the smart device 14 and receives user input. The collection unit is implemented by the control unit 46A of the smart device 14 or a specific processing unit 290 of the data processing apparatus 12 and collects input content received by the reception unit. The generation unit is implemented by the specific processing unit 290 of the data processing apparatus 12 and generates an SQL query based on the collected input content. The provision unit is implemented by the control unit 46A of the smart device 14 or the specific processing unit 290 of the data processing apparatus 12 and provides the generated SQL query. The correspondence between each unit and the apparatus or control unit is not limited to the examples described above and various modifications are possible.

### Second Embodiment

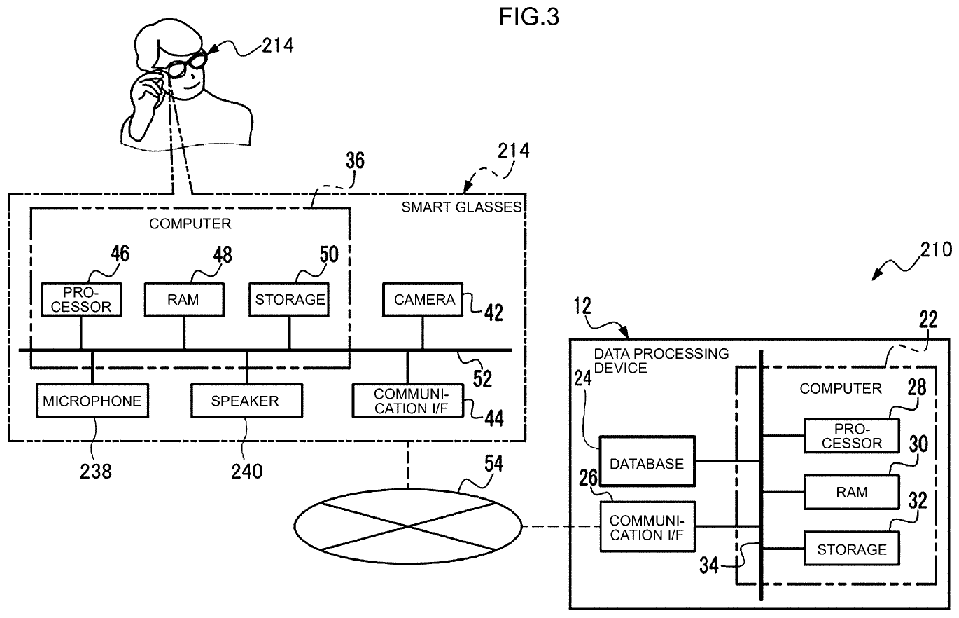

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

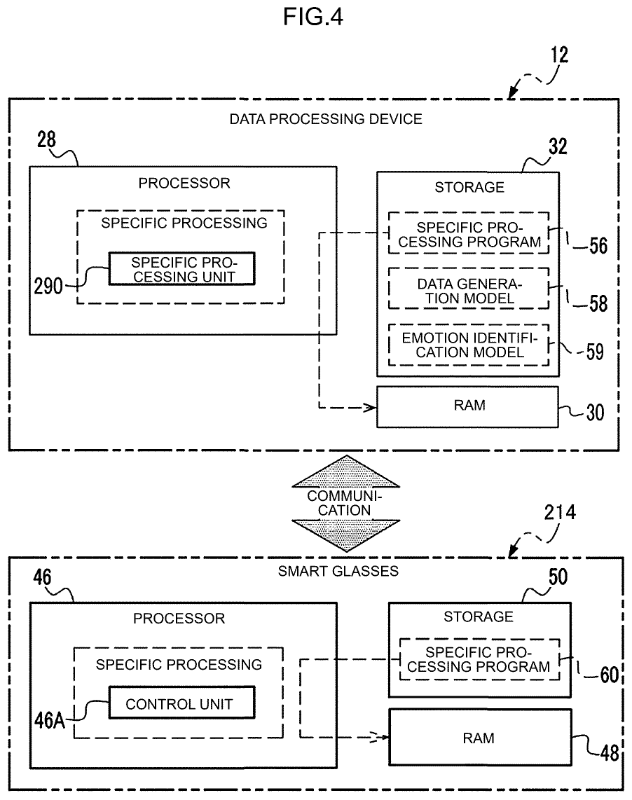

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned reception unit, collection unit, generation unit, and provision unit is implemented by at least one of, for example, the smart glasses 214 and the data processing apparatus 12. For example, the reception unit is implemented by a control unit 46A of the smart glasses 214 and receives user input. The collection unit is implemented by the control unit 46A of the smart glasses 214 or a specific processing unit 290 of the data processing apparatus 12 and collects input content received by the reception unit. The generation unit is implemented by the specific processing unit 290 of the data processing apparatus 12 and generates an SQL query based on the collected input content. The provision unit is implemented by the control unit 46A of the smart glasses 214 or the specific processing unit 290 of the data processing apparatus 12 and provides the generated SQL query. The correspondence between each unit and the apparatus or control unit is not limited to the examples described above and various modifications are possible.

### Third Embodiment

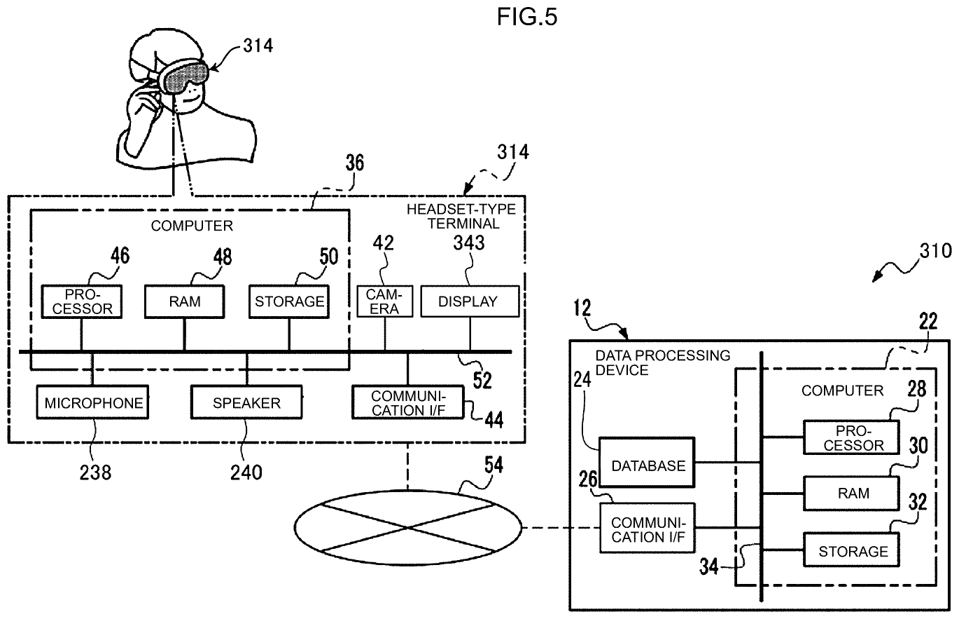

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

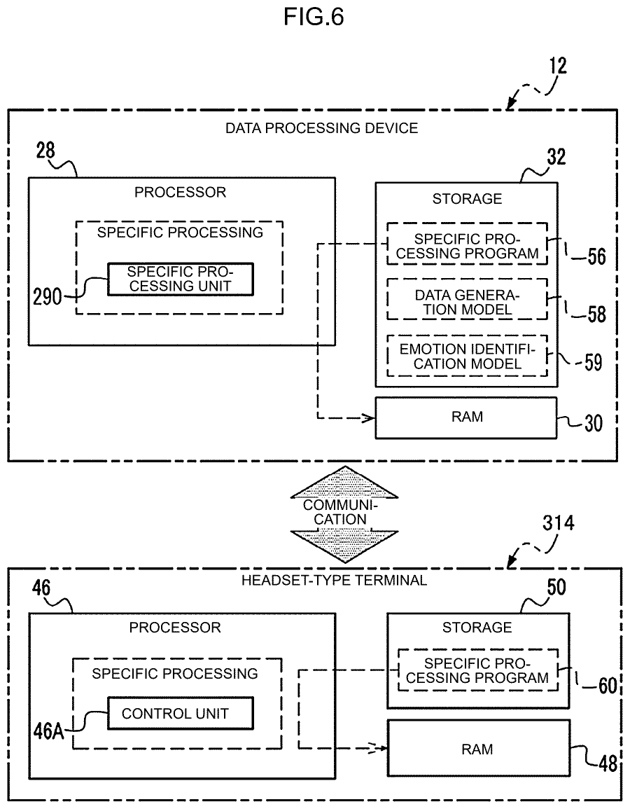

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned reception unit, collection unit, generation unit, and provision unit is implemented by at least one of, for example, the headset-type terminal 314 and the data processing apparatus 12. For example, the reception unit is implemented by a control unit 46A of the headset-type terminal 314 and receives user input. The collection unit is implemented by the control unit 46A of the headset-type terminal 314 or a specific processing unit 290 of the data processing apparatus 12 and collects input content received by the reception unit. The generation unit is implemented by the specific processing unit 290 of the data processing apparatus 12 and generates an SQL query based on the collected input content. The provision unit is implemented by the control unit 46A of the headset-type terminal 314 or the specific processing unit 290 of the data processing apparatus 12 and provides the generated SQL query. The correspondence between each unit and the apparatus or control unit is not limited to the examples described above and various modifications are possible.

### Fourth Embodiment

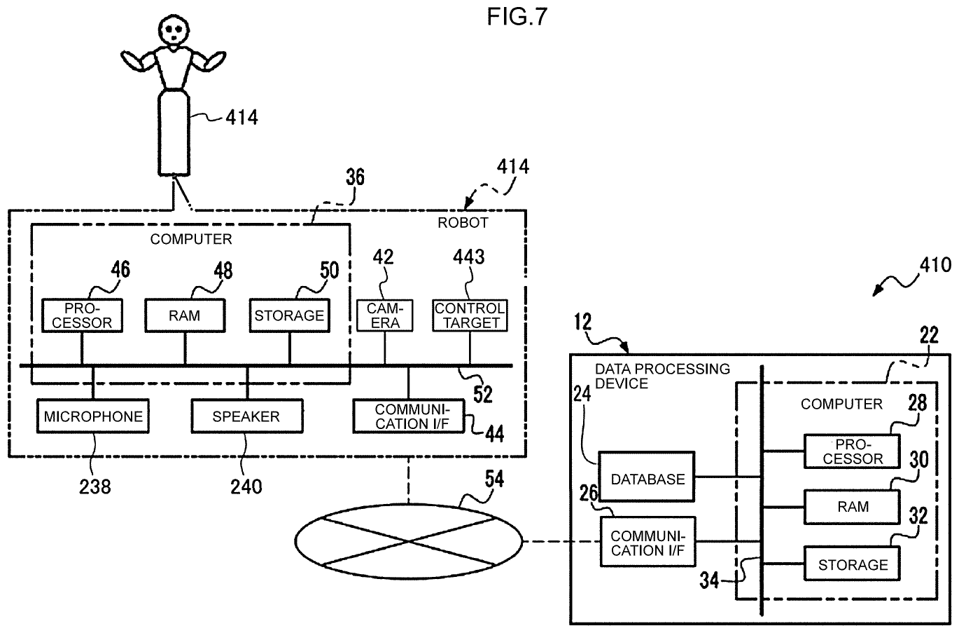

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

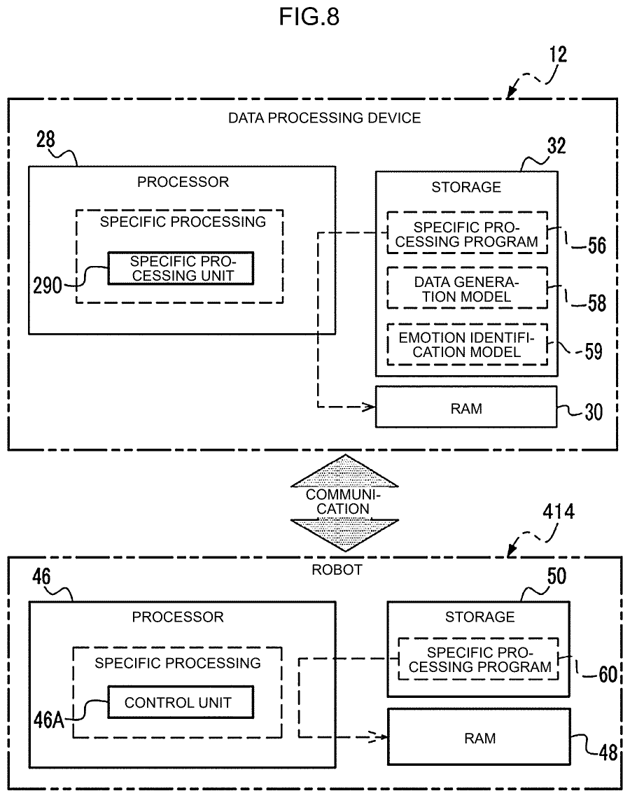

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned reception unit, collection unit, generation unit, and provision unit is implemented by at least one of, for example, the robot 414 and the data processing apparatus 12. For example, the reception unit is implemented by a control unit 46A of the robot 414 and receives user input. The collection unit is implemented by the control unit 46A of the robot 414 or a specific processing unit 290 of the data processing apparatus 12 and collects input content received by the reception unit. The generation unit is implemented by the specific processing unit 290 of the data processing apparatus 12 and generates an SQL query based on the collected input content. The provision unit is implemented by the control unit 46A of the robot 414 or the specific processing unit 290 of the data processing apparatus 12 and provides the generated SQL query. The correspondence between each unit and the apparatus or control unit is not limited to the examples described above and various modifications are possible.

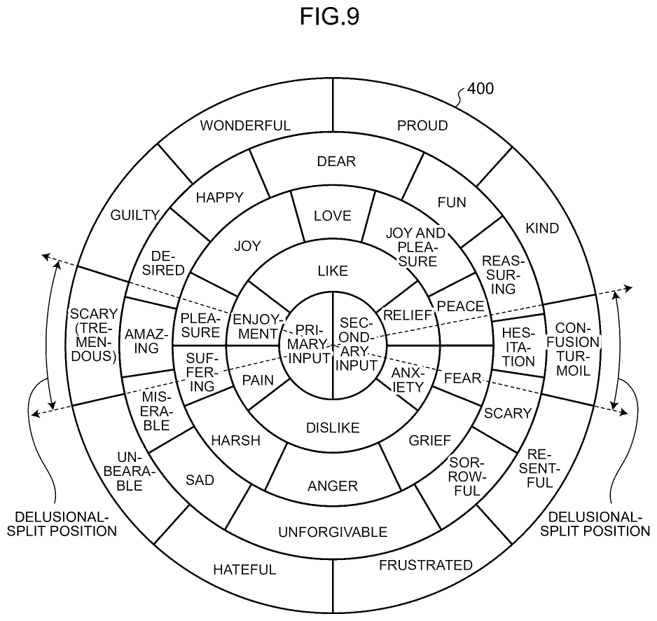

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

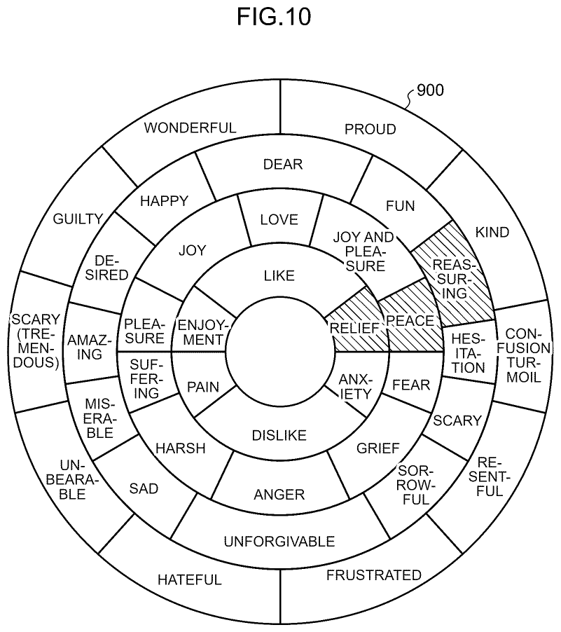

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a reception unit configured to receive user input; a collection unit configured to collect input content received by the reception unit; a generation unit configured to generate an SQL query based on the input content collected by the collection unit; and a provision unit configured to provide the SQL query generated by the generation unit.
(Supplementary Note 2) The system according to Supplementary Note 1, wherein the generation unit comprises an update unit configured to update mart definitions.
(Supplementary Note 3) The system according to Supplementary Note 1, wherein the generation unit comprises a customization unit configured to perform customization according to each company.
(Supplementary Note 4) The system according to Supplementary Note 1, wherein the provision unit is configured to display an execution result of the generated SQL query.
(Supplementary Note 5) The system according to Supplementary Note 1, wherein the reception unit is configured to estimate a user's emotion and change a design of an input interface in real time based on the estimated user's emotion.
(Supplementary Note 6) The system according to Supplementary Note 1, wherein the reception unit is configured to analyze a user's past input history and propose an appropriate input method.
(Supplementary Note 7) The system according to Supplementary Note 1, wherein the reception unit is configured to add a function to immediately perform input completion according to the user's input content.
(Supplementary Note 8) The system according to Supplementary Note 1, wherein the reception unit is configured to estimate a user's emotion and set a priority of input based on the estimated user's emotion.
(Supplementary Note 9) The system according to Supplementary Note 1, wherein the reception unit is configured to provide a region-specific input format based on the user's geographic location information.
(Supplementary Note 10) The system according to Supplementary Note 1, wherein the reception unit is configured to analyze a user's social media activity and propose appropriate input content.
(Supplementary Note 11) The system according to Supplementary Note 1, wherein the collection unit is configured to estimate a user's emotion and adjust a range of data to be collected based on the estimated user's emotion.
(Supplementary Note 12) The system according to Supplementary Note 1, wherein the collection unit is configured to refer to a user's past input content during collection to improve collection accuracy.
(Supplementary Note 13) The system according to Supplementary Note 1, wherein the collection unit is configured to filter collected data based on a user's current business status during collection.
(Supplementary Note 14) The system according to Supplementary Note 1, wherein the collection unit is configured to estimate a user's emotion and determine a priority of collected data based on the estimated user's emotion.
(Supplementary Note 15) The system according to Supplementary Note 1, wherein the collection unit is configured to preferentially collect highly relevant data by considering a user's geographic location information during collection.
(Supplementary Note 16) The system according to Supplementary Note 1, wherein the collection unit is configured to analyze a user's social media activity during collection and collect relevant data.
(Supplementary Note 17) The system according to Supplementary Note 1, wherein the generation unit is configured to estimate a user's emotion and adjust an expression method of the SQL query to be generated based on the estimated user's emotion.
(Supplementary Note 18) The system according to Supplementary Note 1, wherein the generation unit is configured to generate an optimal query by considering a database load during generation.
(Supplementary Note 19) The system according to Supplementary Note 1, wherein the generation unit is configured to apply different generation algorithms according to a user's business content during generation.
(Supplementary Note 20) The system according to Supplementary Note 1, wherein the generation unit is configured to estimate a user's emotion and determine a priority of the SQL query to be generated based on the estimated user's emotion.
(Supplementary Note 21) The system according to Supplementary Note 1, wherein the generation unit is configured to generate an optimal query by considering a geographic distribution of databases during generation.
(Supplementary Note 22) The system according to Supplementary Note 1, wherein the generation unit is configured to refer to related documents during generation to improve generation accuracy.
(Supplementary Note 23) The system according to Supplementary Note 1, wherein the provision unit is configured to estimate a user's emotion and adjust a display method of the SQL query to be provided based on the estimated user's emotion.
(Supplementary Note 24) The system according to Supplementary Note 1, wherein the provision unit is configured to refer to a user's past query execution history during provision to select an optimal display method.
(Supplementary Note 25) The system according to Supplementary Note 1, wherein the provision unit is configured to apply different display algorithms according to a user's business content during provision.
(Supplementary Note 26) The system according to Supplementary Note 1, wherein the provision unit is configured to estimate a user's emotion and determine a priority of the SQL query to be provided based on the estimated user's emotion.
(Supplementary Note 27) The system according to Supplementary Note 1, wherein the provision unit is configured to select an optimal display method by considering a user's geographic location information during provision.
(Supplementary Note 28) The system according to Supplementary Note 1, wherein the provision unit is configured to refer to related documents during provision to improve display accuracy.
(Supplementary Note 29) The system according to Supplementary Note 2, wherein the update unit is configured to estimate a user's emotion and adjust a timing of update based on the estimated user's emotion.
(Supplementary Note 30) The system according to Supplementary Note 2, wherein the update unit is configured to refer to past update history during update to select an optimal update method.
(Supplementary Note 31) The system according to Supplementary Note 2, wherein the update unit is configured to estimate a user's emotion and determine a priority of update based on the estimated user's emotion.
(Supplementary Note 32) The system according to Supplementary Note 2, wherein the update unit is configured to select an optimal update method by considering a geographic distribution of databases during update.
(Supplementary Note 33) The system according to Supplementary Note 3, wherein the customization unit is configured to estimate a user's emotion and adjust customization content based on the estimated user's emotion.
(Supplementary Note 34) The system according to Supplementary Note 3, wherein the customization unit is configured to refer to a user's past customization history during customization to select an optimal customization method.
(Supplementary Note 35) The system according to Supplementary Note 3, wherein the customization unit is configured to estimate a user's emotion and determine a priority of customization based on the estimated user's emotion.
(Supplementary Note 36) The system according to Supplementary Note 3, wherein the customization unit is configured to select an optimal customization method by considering a user's geographic location information during customization.
(Supplementary Note 37) The system according to Supplementary Note 4, wherein the display unit is configured to estimate a user's emotion and adjust a display method based on the estimated user's emotion.
(Supplementary Note 38) The system according to Supplementary Note 4, wherein the display unit is configured to refer to a user's past display history during display to select an optimal display method.
(Supplementary Note 39) The system according to Supplementary Note 4, wherein the display unit is configured to estimate a user's emotion and determine a priority of display based on the estimated user's emotion.
(Supplementary Note 40) The system according to Supplementary Note 4, wherein the display unit is configured to select an optimal display method by considering a user's device information during display.

What is claimed is:

1. A system comprising:
circuitry configured to:
receive, via a communication interface coupled to a packet-switched network, input data from a client terminal, wherein the input data comprises a natural-language token sequence;
apply a tokenizer to the natural-language token sequence to generate a subword token array;
input the subword token array into a Transformer-based neural network comprising an encoder layer to extract structural feature data comprising table identifiers, column identifiers, and conditional operators;
generate, based on the structural feature data and database schema information, a structured query statement represented as an abstract syntax tree; and
transmit, via the communication interface, response data comprising the structured query statement to the client terminal.

2. The system according to claim 1, wherein the circuitry is further configured to compare the database schema information against stored schema data using a difference detection algorithm comprising at least one of structural comparison or hash value comparison, detect a schema change, and update a query generation template to reflect the detected schema change.

3. The system according to claim 1, wherein the circuitry is further configured to receive a company identifier and an industry attribute code associated with the client terminal, select a fine-tuned version of the Transformer-based neural network corresponding to the industry attribute code, and generate the structured query statement using the selected fine-tuned version.

4. The system according to claim 1, wherein the circuitry is further configured to execute the structured query statement against a database to obtain an execution result data set, and transmit the execution result data set to the client terminal together with the structured query statement.

5. The system according to claim 4, wherein the circuitry is further configured to analyze data types, distributions, and category information of the execution result data set using a visualization selection model, select a visualization format from a plurality of visualization formats based on the analysis, and transmit visualization parameters specifying the selected visualization format to the client terminal.

6. The system according to claim 1, wherein the input data further comprises voice data, and the circuitry is further configured to convert the voice data into a spectrogram tensor using a voice recognition model comprising at least one of a recurrent neural network transducer or a Transformer-based voice recognition model, and concatenate feature data extracted from the spectrogram tensor with the subword token array before inputting into the Transformer-based neural network.

7. The system according to claim 1, wherein the input data further comprises image data, and the circuitry is further configured to extract a feature map from the image data using a convolutional neural network, and concatenate feature data extracted from the feature map with the subword token array before inputting into the Transformer-based neural network.

8. The system according to claim 1, wherein the circuitry is further configured to apply the Transformer-based neural network to generate a confidence score for the structured query statement, compare the confidence score against a threshold value, and transmit the structured query statement to the client terminal only when the confidence score meets or exceeds the threshold value.

9. The system according to claim 1, wherein the circuitry is further configured to retrieve, from an input history database, past input records associated with a user identifier of the client terminal, input the past input records into a time-series recurrent neural network to generate a prediction of a next input method and candidate input content, and transmit the candidate input content to the client terminal.

10. The system according to claim 1, wherein the circuitry is further configured to receive a partial token sequence from the client terminal, input the partial token sequence into a language model to generate completion candidates comprising next token predictions mapped to a syntax tree of the structured query statement, and transmit the completion candidates to the client terminal.

11. The system according to claim 1, wherein the circuitry is further configured to receive emotion-related data from the client terminal, input the emotion-related data into an emotion identification model to generate an emotion category and an emotion intensity score, and adjust a processing parameter of the structured query statement generation based on the emotion intensity score.

12. The system according to claim 11, wherein the emotion-related data comprises at least one of a voice spectrogram, a facial image feature map, or a biometric signal vector, and the emotion identification model comprises a multimodal Transformer that integrates features across the at least one of the voice spectrogram, the facial image feature map, or the biometric signal vector.

13. The system according to claim 1, wherein the circuitry is further configured to receive geographic location data from the client terminal, link the geographic location data with a region identification model comprising a geographic information clustering model, and adjust a collection priority of input data based on region-specific parameters associated with the geographic location data.

14. The system according to claim 1, wherein the circuitry is further configured to acquire, via the communication interface, social media post data comprising at least one of text data, image data, or activity record data, apply a text analysis model to the social media post data, and extract supplemental feature data for use in generating the structured query statement.

15. The system according to claim 1, wherein the circuitry is further configured to receive business status data comprising a current business type and a task progress indicator from the client terminal, input the business status data into a business status analysis model, and filter the input data based on priority scores output by the business status analysis model.

16. The system according to claim 1, wherein the database schema information comprises structured data in at least one of JSON format or YAML format, and the structured data specifies table names, column names, data type information, and index information for a target database.

17. The system according to claim 1, wherein the circuitry is further configured to store the structured query statement and a corresponding user identifier in a query history database, and input the stored query history data into the Transformer-based neural network as additional context features when generating a subsequent structured query statement for the same user identifier.

18. A system comprising:
circuitry configured to:
receive, via a communication interface coupled to a packet-switched network, input data from a client terminal, wherein the input data comprises a natural-language token sequence having a maximum length of 512 to 2048 tokens;
apply a tokenizer to the natural-language token sequence to generate a subword token array;
input the subword token array into a Transformer-based neural network comprising an encoder layer having parameters numbering in a range of one billion to one hundred billion, the encoder layer extracting structural feature data comprising table identifiers, column identifiers, conditional operators, and join relationships from the subword token array;
retrieve database schema information comprising structured data specifying table names, column names, data type information, and index information;
generate, by mapping the structural feature data and the database schema information in a high-dimensional semantic space of the Transformer-based neural network, a structured query statement represented as an abstract syntax tree comprising a token sequence of query keywords, table references, column references, and conditional expressions;
compute a confidence score for the structured query statement and compare the confidence score against a threshold value; and
transmit, via the communication interface, response data comprising the structured query statement to the client terminal when the confidence score meets or exceeds the threshold value.

19. The system according to claim 18, wherein the circuitry is further configured to compare the database schema information against previously stored schema data using a difference detection algorithm, detect addition of a new column, and automatically incorporate the new column into the structured query statement by updating the abstract syntax tree.

20. A method performed by circuitry of a system, the method comprising:
receiving, via a communication interface coupled to a packet-switched network, input data from a client terminal, wherein the input data comprises a natural-language token sequence;
applying a tokenizer to the natural-language token sequence to generate a subword token array;
inputting the subword token array into a Transformer-based neural network comprising an encoder layer to extract structural feature data comprising table identifiers, column identifiers, and conditional operators;
generating, based on the structural feature data and database schema information, a structured query statement represented as an abstract syntax tree; and
transmitting, via the communication interface, response data comprising the structured query statement to the client terminal.
